(19) United States
(12) Patent Application Publication
(10) Pub. No.: US 2007/0134587 A1
(43) Pub. Date: Jun. 14, 2007

(54) Lithographic printing plate precursor and lithographic printing method

(75) Inventor: Tomoyoshi Mitsumoto, Haibara-gun (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/523,652

(22) Filed: Sep. 20, 2006

(30) Foreign Application Priority Data
Dec. 8, 2005 (JP) P2005-355193

(51) Int. Cl. G03C 1/00

(52) U.S. Cl. 430/270.1

(57) ABSTRACT

A lithographic printing plate precursor comprising a support and an image-forming layer which is capable of being removed with at least one of a printing ink and dampening water, wherein the image-forming layer contains a stratiform compound.

### FIELD OF THE INVENTION

The present invention relates to a lithographic printing plate precursor and a lithographic printing method by using the same. More specifically, it relates to a lithographic printing plate precursor capable of undergoing a so-called direct plate-making, which can be directly plate-made by scanning of laser beam based on digital signals, for example, a computer, and a lithographic printing method whereby printing is conducted by developing the above-described lithographic printing plate precursor on a printing machine without resorting to the development processing step.

### BACKGROUND OF THE INVENTION

In general, a lithographic printing plate is composed of an oleophilic image area accepting an ink and a hydrophilic non-image area accepting dampening water in the process of printing. Lithographic printing is a printing method utilizing the nature of dampening water and an oily ink to repel with each other and comprising rendering the oleophilic image area of the lithographic printing plate to an ink-receptive area and the hydrophilic non-image area thereof to a dampening water-receptive area (ink-unreceptive area), thereby making a difference in adherence of the ink on the surface of the lithographic printing plate, depositing the ink only to the image area, and then transferring the ink to a printing material, for example, paper. In order to produce the lithographic printing plate, a lithographic printing plate precursor (PS plate) comprising a hydrophilic support having provided thereon an oleophilic photosensitive resin layer (image-forming layer) has heretofore been broadly used. Ordinarily, the lithographic printing plate is obtained by conducting plate-making according to a method of exposing the lithographic printing plate precursor through an original, for example, a lith film, and then while leaving the image area of the image-forming layer, removing the image-forming layer in other unnecessary areas by dissolving with an alkaline developer or an organic solvent thereby revealing the hydrophilic surface of support.

In the hitherto known plate-making process of lithographic printing plate precursor, after exposure, the step of removing the unnecessary image-forming layer by dissolving, for example, with a developer is required. However, it is one of the subjects to save or simplify such an additional wet treatment described above. Particularly, since disposal of liquid wastes discharged accompanying the wet treatment has become a great concern throughout the field of industry in view of the consideration for global environment in recent years, the demand for the solution of the above-described subject has been increased more and more.

As one of simple plate-making methods in response to the above-described requirement, a method referred to as on-machine development has been proposed wherein a lithographic printing plate precursor having an image-forming layer capable of being removed in the unnecessary areas during a conventional printing process is used and after exposure, the non-image area of the image-forming layer is removed on a printing machine to prepare a lithographic printing plate.

Specific methods of the on-machine development include, for example, a method of using a lithographic printing plate precursor having an image-forming layer that can be dissolved or dispersed in dampening water, an ink solvent or an emulsion of dampening water and ink, a method of mechanically removing an image-forming layer by contact with rollers or a blanket cylinder of a printing machine, and a method of lowering cohesion force of an image-forming layer or adhesion between an image-forming layer and a support upon penetration of dampening water, ink solvent or the like and then mechanically removing the image-forming layer by contact with rollers or a blanket cylinder of a printing machine.

In the invention, unless otherwise indicated particularly, the term “development processing step” means a step of using an apparatus (ordinarily, an automatic developing machine) other than a printing machine and removing an unexposed area in an image-forming layer of a lithographic printing plate precursor upon contact with liquid (ordinarily, an alkaline developer) thereby revealing a hydrophilic surface of support. The term “on-machine development” means a method and a step of removing an unexposed area in an image-forming layer of the lithographic printing plate precursor upon contact with liquid (ordinarily, a printing ink and/or dampening water) by using a printing machine thereby revealing a hydrophilic surface of support.

On the other hand, digitalized technique of electronically processing, accumulating and outputting image data using a computer has been popularized in recent years, and various new image-outputting systems responding to the digitalized technique have been put into practical use. Correspondingly, attention has been drawn to a computer-to-plate technique of carrying digitalized image data on highly converging radiation, for example, a laser beam and conducting scanning exposure of a lithographic printing plate precursor with the radiation thereby directly preparing a lithographic printing plate without using a lith film. Thus, it is one of important technical subjects to obtain a lithographic printing plate precursor adaptable to the technique described above.

As described above, in recent years, the simplification of plate-making operation and the realization of dry system and non-processing system have been further strongly required from both aspects of the consideration for global environment and the adaptation for digitization.

In recent years, high output lasers such as semiconductor lasers and YAG lasers are available less expensively. Accordingly, it is highly expected that these high output lasers are useful as image recording light sources in a method of producing a lithographic printing plate precursor by scanning exposure which can be easily incorporated into the digitalization technology. In the conventional plate making method, a photosensitive lithographic printing plate precursor is imagewise-exposed at a low to medium illumination intensity and thus an image is recorded via an imagewise change in a physical property due to a photochemical reaction in the image-forming layer. In the method with the use of the high-output lasers as described above, in contrast thereto, an area to be exposed is radiated with much light energy within an extremely short time. Thus, the light energy is efficiently converted into heat energy, thereby inducing a heat change such as a chemical change, a phase change or a morphological or structural change in the image-forming layer. Using this change, an image is recorded. That is to say, the image data is input by the light energy such as laser beams, while image-recording is carried out by using not only the light energy but also the reaction by heat energy. Such a recording system with the use of the heat generated by high power density exposure is called “heat mode recording” and the conversion of light energy into heat energy is called “photothermal conversion”.

Large merits of the plate making method with the use of the heat mode recording reside in that the image forming layer would not become light-struck at an ordinary illumination level such as room light, and that fixation of an image recorded by high illumination exposure is not essentially required. That is, a lithographic printing plate precursor to be used in heat mode recording is free from any fear of light-struck due to room light before the exposure and the fixation of an image is not essentially required after the exposure. When a plate making process, wherein an image forming layer insolubilized or solubilized by the exposure using high output lasers is employed and the imagewise-exposed image forming layer is employed as a lithographic printing plate, is carried out by the on-machine development, for example, it is expected that a printing system in which an image is not affected even though it is exposed to environmental room light after the exposure could be obtained Accordingly, it is expected that use of the heat mode recording enables the acquisition of a lithographic printing plate precursor appropriately usable in the on-machine development method.

As such a lithographic printing plate precursor, for example, a lithographic printing plate precursor comprising a hydrophilic support having provided thereon an image-forming layer containing a hydrophobic thermoplastic polymer particles dispersed in a hydrophilic binder is known (refer to, for example, Japanese Patent No. 2938397). The lithographic printing plate precursor can be subjected to the on-machine development by exposing with an infrared laser, fusing and coalescing the hydrophobic thermoplastic polymer particles by heat to form an image, loading on a cylinder of a printing machine, and supplying dampening water and/or ink. Although such a method of forming an image by coalescence due to mere heat fusion of polymer fine particles certainly shows good on-machine developing property, the image strength (adhesion to the support) is extremely weak and printing durability is insufficient.

To overcome this problem, there is also proposed to improve printing durability by taking advantage of polymerization. For example, JP-A-2001-277740 and JP-A-2001-277742 disclose a lithographic printing plate precursor comprising a hydrophilic support having provided thereon an image-forming layer (a heat-sensitive layer) containing fine particles having a polymerized compound encapsulated therein. Further, JP-A-2002-287334 discloses a lithographic printing plate precursor which comprises a support having provided thereon an image-forming layer (a photosensitive layer) containing an infrared absorber, a radical polymerization initiator and a polymerizable compound. In these methods of using a polymerization reaction, the density of chemical bonding of the image area is high as compared with the image area formed by the heat fusion of polymer fine particles, therefore it is possible to increase image strength. However, these techniques are still insufficient in printing durability, polymerization efficiency (sensitivity), time-lapse stability and so on from the practical viewpoints.

### SUMMARY OF THE INVENTION

An object of the invention is to provide a lithographic printing plate precursor which enables laser image-recording and on-machine development and has a high sensitivity (fine line reproducibility and printing durability) and a high time-lapse stability and which can be prevented from the adhesion to a paper board and abrasion due to exposure, and a lithographic printing method by using the lithographic printing plate precursor.

The present inventor has paid attentions to components constituting an image-recording material to be used in an image-forming layer of a lithographic printing plate precursor and conducted intensive studies. As a result, the inventor has found out that the above-described objects can be achieved by adding a stratiform compound to the image-forming layer, thereby completing the present invention.

Accordingly, the invention is as follows.

1. A lithographic printing plate precursor comprising a support and an image-forming layer which can be removed with a printing ink, dampening water or both of them, wherein the image-forming layer contains a stratiform compound.

2. A lithographic printing plate precursor as described in the above 1, wherein the aspect ratio of the stratiform compound is 20 or more.

3. A lithographic printing plate precursor as described in the above 1 or 2, wherein an undercoat layer containing a compound having a polymerizable group is formed between the support and the image-forming layer.

4. A lithographic printing plate precursor as described in the above 1 or 2, wherein the image-forming layer further contains a compound having a polymerizable group and an adsorbing group to the support in its molecule.

5. A lithographic printing plate precursor as described in any one of the above 1 to 4, wherein the image-forming layer contains a microcapsule or a microgel.

6. A lithographic printing plate precursor as described in any one of the above 1 to 5, wherein the stratiform compound contains an organic cation.

7. A lithographic printing method comprising loading a lithographic printing plate precursor including a support and an image-forming layer containing a stratiform compound on a printing machine and then imagewise exposing it with an infrared laser, or imagewise exposing the lithographic printing plate precursor with an infrared laser and then loading it on a printing machine, supplying a printing ink and dampening water to the lithographic printing plate precursor to remove an infrared laser-unexposed area of an image-forming layer thereof and conducting printing.

According to the invention, it is possible to provide a lithographic printing plate precursor which enables laser image-recording and on-machine development, has a high sensitivity (fine line reproducibility and printing durability) and a high time-lapse stability and a lithographic printing method by using the lithographic printing plate precursor. According to the invention, moreover, it is possible to prevent a lithographic printing plate precursor from abrasion due to the adhesion of the lithographic printing plate precursor to a paper board and exposure in the case of forming a laminate with the use of the paper board.

### BRIEF DESCRIPTION OF THE DRAWINGS

FIG. 1 is a package of lithographic printing plate precursor.

### DESCRIPTION OF THE REFERENCE NUMERALS AND SIGNS

6 Package of lithographic printing plate precursor
7 Pressure-sensitive adhesive tape

### DETAILED DESCRIPTION OF THE INVENTION

Next, the constituting elements of the lithographic printing plate precursor according to the invention and the lithographic printing method according to the invention will be described in greater detail.

[Image-forming Layer]

The lithographic printing plate precursor of the invention is characterized by comprising a support and an image-forming layer which contains a stratiform compound. It is preferable that the stratiform compound is a compound having an aspect ratio of 20 or more.

By adding such a stratiform compound to the image-forming layer, the following effects can be established. As the first effect, the dispersion of oxygen can be regulated so that the time-lapse stability is improved and the polymerization in the image-forming layer, if employed, is accelerated, thereby elevating the sensitivity and improving the printing durability. As the second effect, the stratiform compound, which is distributed in laminate parallel to the support in the image-forming layer, and enhances the cohesion of the image-forming layer, thereby preventing the transfer onto a medium in contact (a paper board, etc.). As the third effect, the stratiform compound is arranged in laminate and prevents abrasion upon exposure in the case of using a high output laser in the exposure.

The stratiform compound is a particle having a thin tabular shape and examples thereof include mica, for example, natural mica represented by the following general formula:
A(B, C)₂₋₅D₄O₁₀ (OH, F, O)₂ (II)
wherein A represents any one of Li, K, Na, Ca, Mg and an organic cation; B and C each represents any one of Fe (II), Fe(III), Mn, Al, Mg and V; and D represents Si or Al;
or synthetic mica, talc represented by the following formula: 3MgO-4SiO—H₂O, teniolite, montmorillonit, saponite, hectolite and zirconium phosphate.

As examples of the natural mica as described above, there can be enumerated muscovite, paragonite, phlogopite, biotite and lepidolite. As examples of the synthetic mica as described above, there can be enumerated non-swellable mica such as fluorine phlogopite KMg₃(AlSi₃O₁₀)F₂ or potassium tetrasilic mica KMg_{2.5}(Si₄O₁₀)F₂, and swellable mica such as Na tetrasimage-forming layeric mica NaMg_{2.5}(Si₄O₁₀)F₂, Na or Li teniolite (Na, Li)Mg₂Li(Si₄O₁₀)F₂, or montmorillonit based Na or Li hectolite (Na, Li)_{1/8}Mg_{2/5}Li_{1/8}(Si₄O₁₀)F₂. Synthetic smectite is also useful.

Among these stratiform compounds as cited above, fluorine based swellable mica, which is a synthetic inorganic stratiform compound, is particularly useful. Specifically, the swellable synthetic mica and an swellable clay mineral, for example, montmorillonit, saponite, hectoliter or bentonite have a stratiform structure comprising a unit crystal lattice layer having a thickness of approximately 10 to 15 angstroms and metallic atom substitution in the lattices is extremely large in comparison with other clay minerals. As a result, the lattice layer results in lack of positive charge and to compensate it, cations, for example, Li⁺, Na⁺, Ca²⁺, Mg²⁺ or organic cations are adsorbed between the lattice layers. The inorganic stratiform compound swells with water. When share is applied under such condition, the stratiform crystal lattices are easily cleaved to form a stable sol in water. The bentnite and swellable synthetic mica have strong such tendency.

With respect to the shape of the stratiform compound, the thinner the thickness or the larger the plain size as long as smoothness of coated surface and transmission of active ray are not damaged, the better from the standpoint of control of diffusion. Therefore, the aspect ratio of the stratiform compound is preferably 20 or more, more preferably 100 or more, and particularly preferably 200 or more. The aspect ratio is a ratio of thickness to major axis of particle and can be determined, for example, from a projection drawing of particle by a microphotography. The larger the aspect ratio, the greater the effect obtained.

As for the particle size of the stratiform compound, the average particle size is preferably from 1 to 20 μm, more preferably from 1 to 10 μm, and particularly preferably from 2 to 5 μm. When the particle size is less than 1 μm, the inhibition of permeation of oxygen or water is insufficient and the effect of the invention cannot be satisfactorily achieved. On the other hand, when it is larger than 20 μm, the dispersion stability of the particle in the coating solution is insufficient to cause a problem in that stable coating cannot be performed. The average thickness of the particle is preferably 0.1 μm or less, more preferably 0.05 μm or less, and particularly preferably 0.01 μm or less. For example, with respect to the swellable synthetic mica that is the representative compound of the inorganic stratiform compounds, the thickness is approximately from 1 to 50 nm and the plain size is approximately from 1 to 20 μm.

By incorporating particles of the inorganic stratiform compound having such a large aspect ratio into the image-forming layer, the strength of the coating increases and the penetration of oxygen or water can be effectively inhibited, thereby preventing degradation of the image-forming layer due to deformation. Also, even when the lithographic printing plate precursor is stored under a high humidity condition for a long period of time, degradation of the image-forming property of the lithographic printing plate precursor due to the variation of humidity is prevented and the excellent preservation stability is obtained.

The content of the stratiform compound in the image-forming layer is preferably from 0.1 to 50% by weight, more preferably from 3 to 30% by weight and most preferably from 1 to 10% by weight. When multiple types of the stratiform compounds are used together, it is preferred that the total content of the stratiform compounds falls within the range as described above.

Next, an example of ordinary dispersing methods of the stratiform compound will be described below. Specifically, at first, from 5 to 10 parts by weight of a swellable stratiform compound that is exemplified as a preferred stratiform compound is added to 100 parts by weight of water to adapt thoroughly the compound to water and to be swollen, and then the mixture is dispersed using a dispersing machine. The dispersing machine used include, for example, a variety of mills conducting dispersion by directly applying mechanical power, a high-speed agitation type dispersing machine providing a large shear force and a dispersing machine providing ultrasonic energy of high intensity. Specific examples thereof include a ball mill, a sand grinder mill, a visco mill, a colloid mill, a homogenizer, a dissolver, a Polytron, a homomixer, a homoblender, a Keddy mill, a jet agitor, a capillary emulsifying device, a liquid siren, an electromagnetic strain type ultrasonic generator and an emulsifying device having a Polman whistle. The dispersion containing 5 to 10% by weight of the inorganic stratiform compound thus prepared is highly viscous or in the form of gel and exhibits extremely good preservation stability. In the preparation of a coating solution using the dispersion, it is preferred that the dispersion is diluted with water, thoroughly stirred and then blended to give the coating solution.

In the invention, the conditions for additional components to be used in the image-forming layer are not specifically restricted. Next, materials to be employed in the case of using a polymerization reaction will be described in detail.

In the case of using a polymerization reaction, the image-forming layer contains, as additional components, (A) an active ray absorbing agent, (B) a polymerization initiator, and (C) a polymerizable compound.

In the lithographic printing plate precursor, an exposed area of the image-forming layer is hardened due to, for example, infrared exposure to form a hydrophobic (lipophilic) area. At the initiation of printing, an unexposed area is quickly removed from the support by supplying dampening water, an ink or an emulsion comprising an ink and dampening water That is, the image-forming layer serves as an image-forming layer which can be removed by a printing ink and/or dampening water. Next, individual components constituting the image-forming layer will be illustrated.

<(A) Active Ray Absorbing Agent>

In the case of forming an image on the lithographic printing plate precursor of the invention with the use of a laser emitting infrared light of 760 to 1200 nm in wavelength as a light source, it is usually preferable to use an infrared absorbing agent. The infrared absorbing agent has a function of converting absorbed infrared light into heat and another function of being excited by the infrared light and then transferring electrons/energy to a polymerization initiator (a radical generator) as will be described hereinafter. The infrared absorbing agent to be used in the invention is a dye or a pigment having an absorption maximum in a wavelength range of 760 to 1200 nm

As the dye, commercially available dyes and known dyes described in literatures, for example, Senryo Binran (Dye Handbook) compiled by The Society of Synthetic Organic Chemistry, Japan (1970) can be utilized. Specifically, the dyes includes azo dyes, metal complex azo dyes, pyrazolone azo dyes, naphthoquinone dyes, anthraquinone dyes, phthalocyanine dyes, carbonium dyes, quinoneimine dyes, methine dyes, cyanine dyes, squarylium dyes, pyrylium salts and metal thiolate complexes.

Preferred examples of the dye include cyanine dyes described, for example, in JP-A-58-125246, JP-A-59-84356 and JP-A-60-78787; methine dyes described, for example, in JP-A-58-173696, JP-A-58-181690 and JP-A-58-194595; naphthoquinone dyes described, for example, in JP-A-58-112793, JP-A-58-224793, JP-A-59-48187, JP-A-59-73996, JP-A-60-52940 and JP-A-60-63744; squarylium dyes described, for example, in JP-A-58-112792; and cyanine dyes described, for example, in British Patent 434,875.

Also, near infrared absorbing sensitizers described in U.S. Pat. No. 5,156,938 are preferably used. Further, substituted arylbenzo(thio)pyrylium salts described in U.S. Pat. No. 3,881,924, trimethinethiapyrylium salts described in JP-A-57-142645 (corresponding to U.S. Pat. No. 4,327,169), pyrylium compounds described in JP-A-58-181051, JP-A-58-220143, JP-A-59-41363, JP-A-59-84248, JP-A-59-84249, JP-A-59-146063 and JP-A-59-146061, cyanine dyes described in JP-A-59-216146, pentamethinethiopyrylium salts described in U.S. Pat. No. 4,283,475, and pyrylium compounds described in JP-B-5-13514 and JP-B-5-19702 are also preferably used. Other preferred examples of the dye include near infrared absorbing dyes represented by formulae (I) and (II) described in U.S. Pat. No. 4,756,993.

As other preferable examples of the infrared absorbing dye of the invention, there can be enumerated the following specific indolenine cyanine dyes described in JP-A-2002-278057.

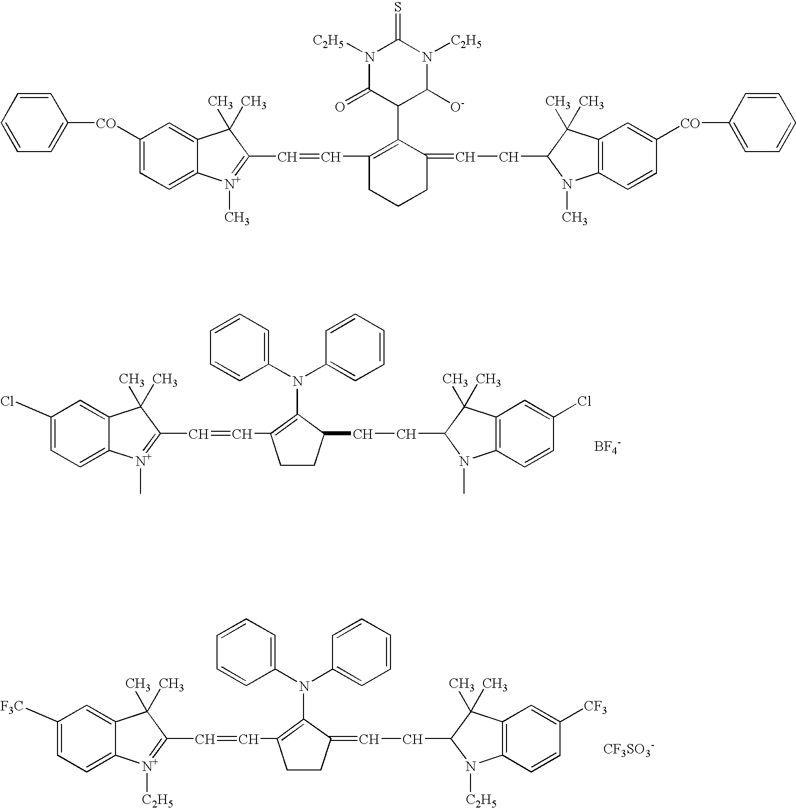

In particular, among the dyes, cyanine dyes, squarylium dyes, pyrylium dyes, nickel thiolate complexes and indolenine cyanine dyes are preferred. Cyanine dyes and indolenine cyanine dyes are more preferred. As a particularly preferred example of the dye, a cyanine dye represented by formula (i) shown below is exemplified.

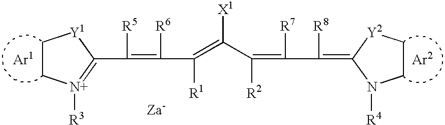

In formula (i), X¹ represents a hydrogen atom, a halogen atom, —NPh₂, X²-L¹ or a group shown below;

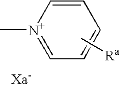

In the above, X² represents an oxygen atom, a nitrogen atom or a sulfur atom, and L¹ represents a hydrocarbon group having from 1 to 12 carbon atoms, an aromatic cyclic group containing a hetero atom or a hydrocarbon group having from 1 to 12 carbon atoms and containing a hetero atom. The hetero atom indicates a nitrogen atom, a sulfur atom, an oxygen atom, a halogen atom or a selenium atom. Xa⁻ has the same meaning as Za⁻ defined hereinafter, and R^{a} represents a hydrogen atom or a substituent selected from an alkyl group, an aryl group, a substituted or unsubstituted amino group and a halogen atom. Ph represents a phenyl group.

In formula (i), R¹ and R² each independently represents a hydrocarbon group having from 1 to 12 carbon atoms. In view of the preservation stability of a coating solution for image-forming layer, it is preferred that R¹ and R² each represents a hydrocarbon group having two or more carbon atoms, and particularly preferably, R¹ and R² are combined with each other to form a 5-membered or 6-membered ring.

In formula (i), Ar¹ and Ar², which may be the same or different, each represents an aromatic hydrocarbon group which may have a substituent. Preferred examples of the aromatic hydrocarbon group include a benzene ring and a naphthalene ring. Also, preferred examples of the substituent include a hydrocarbon group having 12 or less carbon atoms, a halogen atom and an alkoxy group having 12 or less carbon atoms. Y¹ and Y², which may be the same or different, each represents a sulfur atom or a dialkylmethylene group having 12 or less carbon atoms. R³ and R⁴, which may be the same or different, each represents a hydrocarbon group having 20 or less carbon atoms which may have a substituent. Preferred examples of the substituent include an alkoxy group having 12 or less carbon atoms, a carboxy group and a sulfo group. R⁵, R⁶, R⁷ and R⁸, which may be the same or different, each represents a hydrogen atom or a hydrocarbon group having 12 or less carbon atoms. From the standpoint of the availability of raw materials, a hydrogen atom is preferred. Za⁻ represents a counter anion. However, Za⁻ is not necessary when the cyanine dye represented by formula (i) has an anionic substituent in the structure thereof so that neutralization of charge is not needed. Preferred examples of the counter ion for Za⁻ include a halogen ion, a perchlorate ion, a tetrafluoroborate ion, a hexafluorophosphate ion and a sulfonate ion, and particularly preferred examples thereof include a perchlorate ion, a hexafluorophosphate ion and an arylsulfonate ion in view of the preservation stability of a coating solution for image-forming layer.

Specific examples of the cyanine dye represented by formula (i) which can be preferably used in the invention include those described in paragraphs [0017] to [0019] of JP-A-2001-133969.

Further, other particularly preferable examples include specific indolenine cyanine dyes described in JP-A-2002-278057.

Moreover, it is preferred that the infrared absorbing agent is water-soluble. However, when the infrared absorbing agent is water-insoluble, it can be incorporated by a method, for example, dispersion or dissolution in a mixed solvent.

Examples of the pigment used in the invention include commercially available pigments and pigments described in Colour Index (C.I.), Saishin Ganryo Binran (Handbook of Newest Pigments) compiled by Pigment Technology Society of Japan (1977), Saishin Ganryo Oyou Gijutsu (Newest Application Technologies of Pigments), CMC Publishing Co., Ltd. (1986) and Insatsu Ink Gijutsu (Printing Ink Technology), CMC Publishing Co., Ltd. (1984).

Examples of the pigment include black pigments, yellow pigments, orange pigments, brown pigments, red pigments, purple pigments, blue pigments, green pigments, fluorescent pigments, metal powder pigments and polymer-bonded dyes. Specific examples of the pigment used include insoluble azo pigments, azo lake pigments, condensed azo pigments, chelated azo pigments, phthalocyanine pigments, anthraquinone pigments, perylene and perynone pigments, thioindigo pigments, quinacridone pigments, dioxazine pigments, isoindolinone pigments, quinophthalone pigments, dying lake pigments, azine pigments, nitroso pigments, nitro pigments, natural pigments, fluorescent pigments, inorganic pigments and carbon black. Of the pigments, carbon black is preferred.

The pigment may be used without undergoing surface treatment or may be used after conducting the surface treatment. For the surface treatment, a method of coating a resin or wax on the pigment surface, a method of attaching a surfactant to the pigment surface and a method of bonding a reactive substance (for example, a silane coupling agent, an epoxy compound or polyisocyanate) to the pigment surface. The surface treatment methods are described in Kinzoku Sekken no Seishitsu to Oyo (Properties and Applications of Metal Soap), Saiwai Shobo, InsatAu Ink Gijutsu (Printing Ink Technology), CMC Publishing Co., Ltd (1984), and Saishi Ganryo Oyo Gijutsu (Newest Application Technologies of Pigments), CMC Publishing Co., Ltd. (1986).

A particle size of the pigment is preferably in a range from 0.01 to 10 μm, more preferably in a range from 0.05 to 1 μm, particularly preferably in a range from 0.1 to 1 μm. In the above-described range, good stability of the pigment dispersion in a coating solution for image-forming layer and good uniformity of the image-forming layer can be obtained.

As a method for dispersing the pigment, a known dispersion technique for use in the production of ink or toner may be used. Examples of the dispersing machine include an ultrasonic dispersing machine, a sand mill, an attritor, a pearl mill, a super-mill, a ball mill, an impeller, a disperser, a KD mill, a colloid mill, a dynatron, a three roll mill and a pressure kneader. The dispersing methods are described in detail in Saishin Ganryo Oyo Gijutsu (Newest Application Technologies of Pigments), CMC Publishing Co., Ltd. (1986).

Such an infrared absorbing agent may be added together with other components to a single layer. Alternatively, the infrared absorbing agent may be added to a layer which is separately formed. The infrared absorbing agent is added so that, in constructing a negative lithographic printing plate precursor, the image-forming layer shows an absorbance of from 0.3 to 1.2 (measured by the reflection method), preferably from 0.4 to 1.1, at the maximum absorption wavelength within a wavelength range of from 760 nm to 1200 nm. So long as the absorbance falls within this range, polymerization uniformly proceeds in the depth direction of the image-forming layer and thus a favorable film strength in an image area and an excellent adhesion to the support can be established.

The absorbance of the image-forming layer can be controlled depending on the amount of the infrared absorbing agent to be added to the image-forming layer and the thickness of the image-forming layer. The absorbance can be measured by a method commonly employed. Examples of the measurement method include a method which comprises forming an image-forming layer having a thickness, which is appropriately determined within a range required as a lithographic printing plate precursor by considering the coating amount after drying, on a reflective support (aluminum, etc.) and then measuring the reflection density with an optical densitometer, a method of measuring the reflection by the reflection method with the use of an integral sphere by using a spectrophotometer, etc.

<(B) Polymerization Initiator>

A polymerization generator to be used in the invention means a compound which generates radicals by heat or light energy or both thereof and thus initiates and promotes the polymerization of a compound having a polymerizable unsaturated bond. As the polymerization generator usable in the invention, use may be made of publicly known thermal polymerization initiators, compounds having a bond with a low unbound energy, photopolymerization initiators and so on. The radical-generating compound appropriately usable in the invention means a compound which generates radicals by heat energy and thus initiates and promotes the polymerization of a compound having a polymerizable unsaturated bond. As the radical-generating compound usable in the invention, use may be appropriately made of publicly known polymerization initiators, compounds having a bond with a low unbound energy and so on. Either one of such radical-generating compounds or a combination of two or more thereof may be used.

As examples of the radical-generating compound, there can be enumerated organic halides, carbonyl compounds, organic peroxides, azo-type polymerization initiators, azide compounds, metallocene compounds, hexaaryl biimidazole compounds, organic boric acid compounds, disulfonic acid compounds, oxime ester compounds and onium salt compounds.

The organic halogen compounds described above specifically include, for example, compounds described in Wakabayashi et al., Bull. Chem. Soc. Japan, 42, 2924 (1969), U.S. Pat. No. 3,905,815, JP-B-46-4605, JP-A-48-36281, JP-A-55-32070, JP-A-60-239736, JP-A-61-169835, JP-A-61-169837, JP-A-62-58241, JP-A-62-212401, JP-A-63-70243, JP-A-63-298339 and M. P. Hutt, Journal of Heterocyclic Chemistry, 1, No. 3 (1970). Among them, oxazole compounds and s-triazine compounds each substituted with a trihalomethyl group are preferable.

More preferably, s-triazine derivatives in which at least one mono-, di- or tri-halogen substituted methyl group is connected to the s-triazine ring are exemplified. Specific examples thereof include 2,4,6-tris(monochloromethyl)-s-triazine, 2,4,6-tris(dicbloromethyl)-s-triazine, 2,4,6-tris(trichloromethyl)-s-triazine, 2-methyl-4,6-bis(trichloromethyl)-s-triazine, 2-n-propyl-4,6-bis(trichloromethyl)-s-triazine, 2-(α,α,β-trichloroethyl)-4,6-bis(trichloromethyl)-s-triazine, 2-phenyl-4,6-bis(trichloromethyl)-s-triazine, 2-(p-methoxyphenyl)-4,6-bis(trichlorornethyl)-s-triazine, 2-(3,4-epoxyphenyl)-4,6-bis(trichloromethyl)-s-triazine, 2-(p-chlorophenyl)-4,6-bis(trichloromethyl)-s-triazine, 2-[1-(p-methoxyphenyl)-2,4-butadienyl]-4,6-bis(trichloromethyl)-s-triazine, 2-styryl-4,6-bis(trichloromethyl)-s-triazine, 2-(p-methoxystyryl-4,6-bis(trichloromethyl)-s-triazine, 2-(p-isopropyloxystyryl-4,6bis(trichloromethyl)-s-triazine, 2-(p-tolyl)-4,6-bis(trichloromethyl)-s-triazine, 2-(4-methoxynaphthyl)-4,6-bis(trichloromethyl)-s-triazine, 2-phenylthio-4,6-bis(trichloromethyl)-s-triazine, 2-benzylthio-4,6-bis(trichloromethyl)-s-triazine, 2,4,6-tris(dibromomethyl)-s-triazine, 2,4,6-tris(tribromomethyl)-s-triazine, 2-methyl-4,6-bis(tribromomethyl)-s-triazine and 2-methoxy-4,6-bis(tribromomethyl)-s-triazine.

The carbonyl compounds described above include, for example, benzophenone derivatives, e.g., benzophenone, Michler's ketone, 2-methylbenzophenone, 3-methylbenzophenone, 4-methylbenzophenone, 2-chlorobenzophenone, 4-bromobenzophenone or 2-carboxybenzophenone, aceto phenone derivatives, e.g., 2,2-dimethoxy-2-phenylacetophenone, 2,2-diethoxyacetophenone, 1-hydroxycyclohexylphenylketone, α-hydroxy-2-methylphenylpropane, 1-hydroxy-1-methylethyl-(p-isopropylphenyl)ketone, 1-hydroxy-1-(p-dodecylphenyl)ketone, 2-methyl-(4′-(methylthio)phenyl)-2-morpholino-1-propane or 1,1,1-trichloromethyl-(p-butylphenyl)ketone, thioxantone derivatives, e.g., thioxantone, 2-ethylthioxantone, 2-isopropylthioxantone, 2-chlorothioxantone, 2,4-dimetylthioxantone, 2,4-dietylthioxantone or 2,4-diisopropylthioxantone, and benzoic acid ester derivatives, e.g., ethyl p-dimethylaminobenzoate or ethyl p-diethylaminobenzoate.

The azo compounds described above include, for example, azo compounds described in JP-A-8-108621.

The organic peroxides described above include, for example, trimethylcyclohexanone peroxide, acetylacetone peroxide, 1,1-bis(tert-butylperoxy)-3,3,5-trimethylcyclohexane, 1,1-bis(tert-butylperoxy)cyclohexane, 2,2-bis(tert-butylperoxy)butane, tert-butylhydroperoxide, cumene hydroperoxide, diisopropylbenzene hydroperoxide, 2,5-dimethylhexane-2,5-dihydroperoxide, 1,1,3,3-tetramethylbutyl hydroperoxide, tert-butylcumyl peroxide, dicumyl peroxide, 2,5-dimethyl-2,5-di(tert-butylperoxy)hexane, 2,5-oxanoyl peroxide, succinic peroxide, benzoyl peroxide, 2,4-dichlorobenzoyl peroxide, diisopropylperoxy dicarbonate, di-2-ethylhexylperoxy dicarbonate, di-2-ethoxyethylperoxy dicarbonate, dimethoxyisopropylperoxy dicarbonate, di(3-methyl-3-methoxybutyl)peroxy dicarbonate, tert-butylperoxy acetate, tert-butylperoxy pivalate, tert-butylperoxy neodecanoate, tert-butylperoxy octanoate, tert-butylperoxy laurate, tertiary carbonate, 3,3′,4,4′-tetra(tert-butylperoxycarbonyl)benzophenone, 3,3′,4,4′-tetra(tert-hexylperoxycarbonyl)benzophenone, 3,3′,4,4′-tetra(p-isopropylcumylperoxycarbonyl)benzophenone, carbonyl di(tert-butylperoxydihydrogen diphthalate) and carbonyl di(tert-hexylperoxydihydrogen diphthalate).

The metallocene compounds described above include, for example, various titanocene compounds described in JP-A-59-152396, JP-A-61-151197, JP-A-63-41484, JP-A-2-249, JP-A-2-4705 and JP-A-5-83588, for example, dicyclopentadienyl-Ti-bisphenyl, dicyclopentadienyl-Ti-bis-2,6-difluorophen-1-yl, dicyclopentadienyl-Ti-bis-2,4-difluorophen-1-yl, dicyclopentadienyl-Ti-bis-2,4,6-triafluorophen-1-yl, dicyclopentadienyl-Ti-bis-2,3,5,6-tetrafluorophen-1-yl, dicyclopentadienyl-Ti-bis-2,3,4,5,6-pentafluorophen-1-yl, dimethylcyclopentadienyl-Ti-bis-2,6-difluorophen-1-yl, dimethylcyclopentadienyl-Ti-bis-2,4,6-triafluorophen-1-yl, dimethylcyclopentadienyl-Ti-bis-2,3,5,6-tetrafluorophen-1-yl or dimethylcyclopentadienyl-Ti-bis-2,3,4,5,6-pentafluorophen-1-yl and iron-arene complexes described in JP-A-1-304453 and JP-A-1-152109.

The hexaarylbiimidazole compounds described above include, for example, various compounds described in JP-B-6-29285 and U.S. Pat. Nos. 3,479,185, 4,311,783 and 4,622,286, specifically, for example, 2,2′-bis(o-chlorophenyl)-4,4′,5,5′-tetraphenylbiimidazole, 2,2′-bis(o-bromophenyl)-4,4′,5,5′-tetraphenylbiimidazole, 2,2′-bis(o,p-dichlorophenyl)-4,4′,5,5′-tetraphenylbiimidazole, 2,2′-bis(o-chlorophenyl)-4,4′,5,5′-tetra(m-methoxyphenyl)biimidazole, 2,2′-bis(o,o′-dichlorophenyl)-4,4′,5,5′-tetraphenylbiimidazole, 2,2′-bis(o-nitrophenyl)-4,4′,5,5′-tetraphenylbiimidazole, 2,2′-bis(o-methylphenyl)-4,4′,5,5′-tetraphenylbiimidazole and 2,2′-bis(o-trifluoromethylphenyl)-4,4′,5,5′-tetraphenylbiimidazole.

The organic boron compounds described above include, for example, organic boric acid salts described in JP-A-62-143044, JP-A-62-150242, JP-A-9-188685, JP-A-9-188686, JP-A-9-188710, JP-A-2000-131837, JP-A-2002-107916, Japanese Patent No. 2764769, JP-A-2002-116539 and Martin Kunz, Rad Tech '98, Proceeding, Apr. 10-22, 1998, Chicago, organic boron sulfonium complexes or organic boron oxosulfonium complexes described in JP-A-6-157623, JP-A-6-175564 and JP-A-6-175561, organic boron iodonium complexes described in JP-A-6-175554 and JP-A-6-175553, organic boron phosphonium complexes described in JP-A-9-188710, and organic boron transition metal coordination complexes described in JP-A-6-3480 11, JP-A-7-128785, JP-A-7-140589, JP-A-7-306527 and JP-A-7-292014.

The disulfone compounds described above include, for example, compounds described in JP-A-61-166544 and JP-A-2003-328465.

The oximester compounds described above include, for example, compounds described in J. C. S. Perkin II, 1653-1660 (1979), J. C. S. Perkin II, 156-162 (1979), Journal of Photopolymer Science and Technoly, 202-232 (1995) and JP-A-2000-66385, and compounds described in JP-A-2000-80068, and specifically, compounds represented by the following formulae;

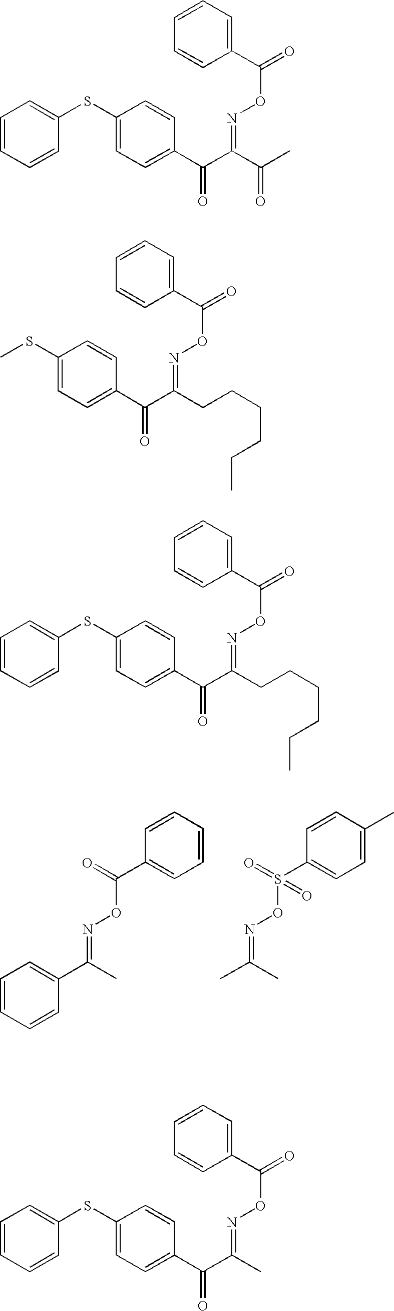

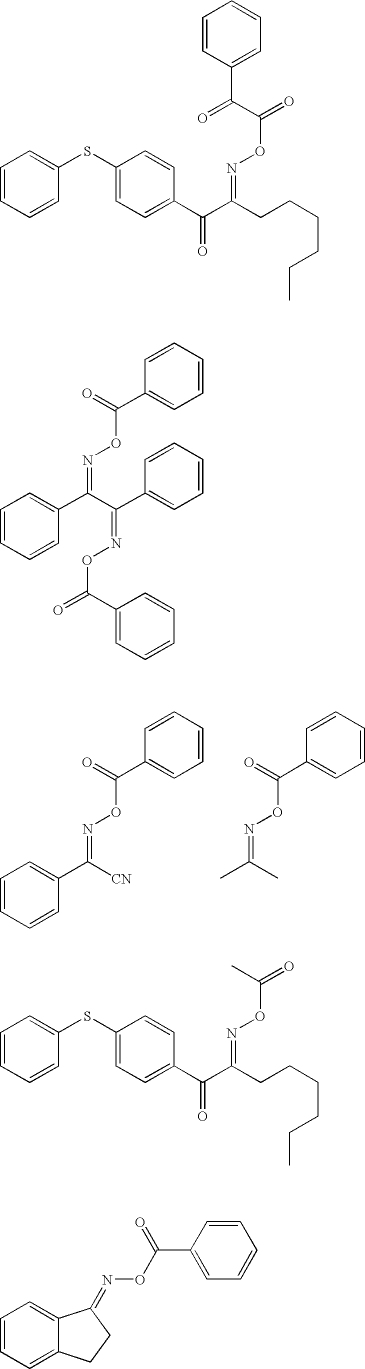

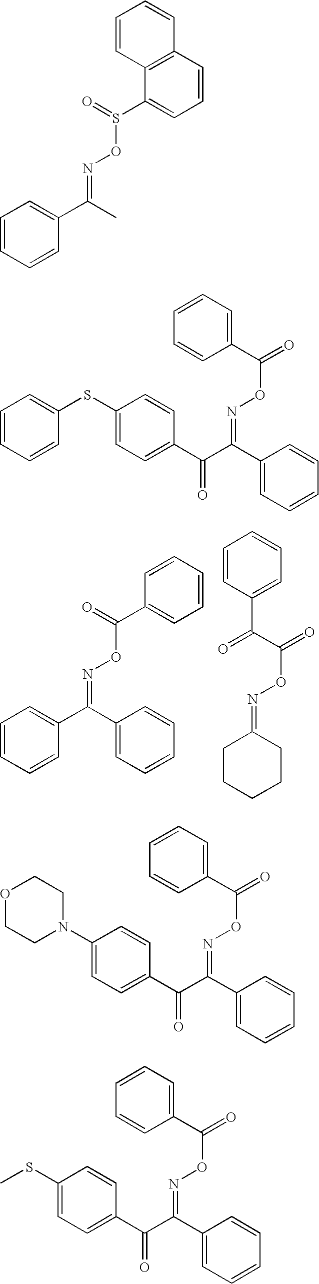

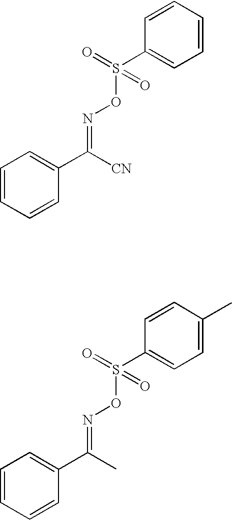

The onium salt compounds described above include, for example, diazonium salts described in S. I. Schlesinger, Photogr. Sci. Eng., 18, 387 (1974) and T. S. Bal et al., Polymer, 21, 423 (1980), ammonium salts described in U.S. Pat. No. 4,069,055 and JP-A-4-365049, phosphonium salts described in U.S. Pat. Nos. 4,069,055 and 4,069,056, iodonium salts described in European Patent 104,143, U.S. Pat. Nos. 339,049 and 410,201, JP-A-2-150848 and JP-A-2-296514, sulfonium salts described in European Patents 370,693, 390,214, 233,567, 297,443 and 297,442, U.S. Pat. Nos. 4,933,377, 161,811, 410,201, 339,049, 4,760,013, 4,734,444 and 2,833,827 and German Patents 2,904,626, 3,604,580 and 3,604,581, selenonium salts described in J. V. Crivello et al., Macromolecules, 10 (6), 1307 (1977) and J. V. Crivello et al., J. Polymer Sci., Polymer Chem. Ed., 17, 1047 (1979), and arsonium salts described in C. S. Wen et al., Teh. Proc. Conf. Rad. Curing ASIA, p. 478, Tokyo, October (1988).

From the standpoint of the reactivity and stability, the above-described oximester compounds and onium salt compounds (diazonium salts, iodoniurn salts and sulfonium salts) are particularly preferably exemplified. In the invention, the onium salt compound functions not as an acid generator, but as an ionic radical polymerization initiator.

The onium salt compounds preferably used in the invention include onium salts represented by the following formulae (RI-I) to (RI-III):

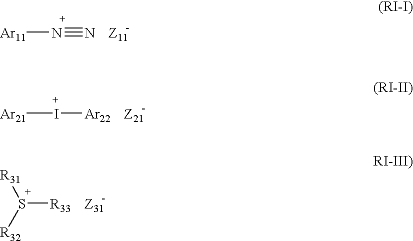

In formula (RI-I), Ar₁₁, represents an aryl group having 20 or less carbon atoms, which may have 1 to 6 substituents. Preferred example of the substituent includes an alkyl group having from 1 to 12 carbon atoms, an alkenyl group having from 2 to 12 carbon atoms, an alkynyl group having from 2 to 12 carbon atoms, an aryl group having from 6 to 12 carbon atoms, an alkoxy group having from 1 to 12 carbon atoms, an aryloxy group having from 6 to 12 carbon atoms, a halogen atom, an alkylamino group having from 1 to 12 carbon atoms, a dialkylimino group having from 2 to 12 carbon atoms, an alkylamido group or arylamido group having from 2 to 12 carbon atoms, a carbonyl group, a carboxy group, a cyano group, a sulfonyl group, an thioalkyl group having from 1 to 12 carbon atoms and an thioaryl group having from 6 to 12 carbon atoms. Z₁₁⁻ represents a monovalent anion Specific examples of the monovalent anion include a halogen ion, a perchlorate ion, a hexafluorophosphate ion, a tetrafluoroborate ion, a sulfonate ion, a sulfinate ion, a thosulfonate ion and a sulfate ion. Among them, the perchlorate ion, bexafluorophosphate ion, tetrafluoroborate ion, sulfonate ion and sulfinate ion are preferred in view of the stability.

In the formula (RI-II), Ar₂₁ and Ar₂₂ each independently represents an aryl group having 20 or less carbon atoms, which may have I to 6 substituents. Preferred example of the substituent includes an alkyl group having from 1 to 12 carbon atoms, an alkenyl group having from 2 to 12 carbon atoms, an alkynyl group having from 2 to 12 carbon atoms, an aryl group having from 6 to 12 carbon atoms, an alkoxy group having from 1 to 12 carbon atoms, an aryloxy group having from 6 to 12 carbon atoms, a halogen atom, an alkylamino group having from 1 to 12 carbon atoms, a dialkylimino group having from 2 to 12 carbon atoms, an alkylamido group or arylamido group having from 2 to 12 carbon atoms, a carbonyl group, a carboxy group, a cyano group, a sulfonyl group, an thioalkyl group having from 1 to 12 carbon atoms and an thioaryl group having from 6 to 12 carbon atoms. Z₂₁⁻ represents a monovalent anion. Specific examples of the monovalent anion include a halogen ion, a perchlorate ion, a hexafluorophosphate ion, a tetrafluoroborate ion, a sulfonate ion, a sulfinate ion, a thosulfonate ion, a sulfate ion and a carboxylate ion. Among them, the perchlorate ion, hexafluorophosphate ion, tetrafluoroborate ion, sulfonate ion, sulfinate ion and carboxylate ion are preferred in view of the stability and reactivity.

In the formula (RI-III), R₃₁, R₃₂ and R₃₃ each independently represents an aryl group, alkyl group, alkenyl group or alkynyl group having 20 or less carbon atoms, which may have 1 to 6 substituents. Among them, the aryl group is preferred in view of the reactivity and stability. Preferred example of the substituent includes an alkyl group having from 1 to 12 carbon atoms, an alkenyl group having from 2 to 12 carbon atoms, an alkynyl group having from 2 to 12 carbon atoms, an aryl group having from 6 to 12 carbon atoms, an alkoxy group having from 1 to 12 carbon atoms, an aryloxy group having from 6 to 12 carbon atoms, a halogen atom, an alkylamino group having from 1 to 12 carbon atoms, a dialkylimino group having from 2 to 12 carbon atoms, an alkylamido group or arylamido group having from 2 to 12 carbon atoms, a carbonyl group, a carboxy group, a cyano group, a sulfonyl group, an thioalkyl group having from 1 to 12 carbon atoms and an thioaryl group having from 6 to 12 carbon atoms. Z₃⁻ represents a monovalent anion. Specific examples of the monovalent anion include a halogen ion, a perchlorate ion, a hexafluorophosphate ion, a tetrafluoroborate ion, a sulfonate ion, a sulfinate ion, a thosulfonate ion and a sulfate ion. Among them, the perchlorate ion, hexafluorophosphate ion, tetrafluoroborate ion, sulfonate ion, sulfinate ion and carboxylate ion are preferred in view of the stability and reactivity. As the anion, carboxylate ions described in JP-A-2001-343742 are more preferably exemplified, and carboxylate ions described in JP-A-2002-148790 are particularly preferably exemplified.

Specific examples of the onium salt compound preferably used in the invention are set forth below, but the invention should not be construed as being limited thereto.

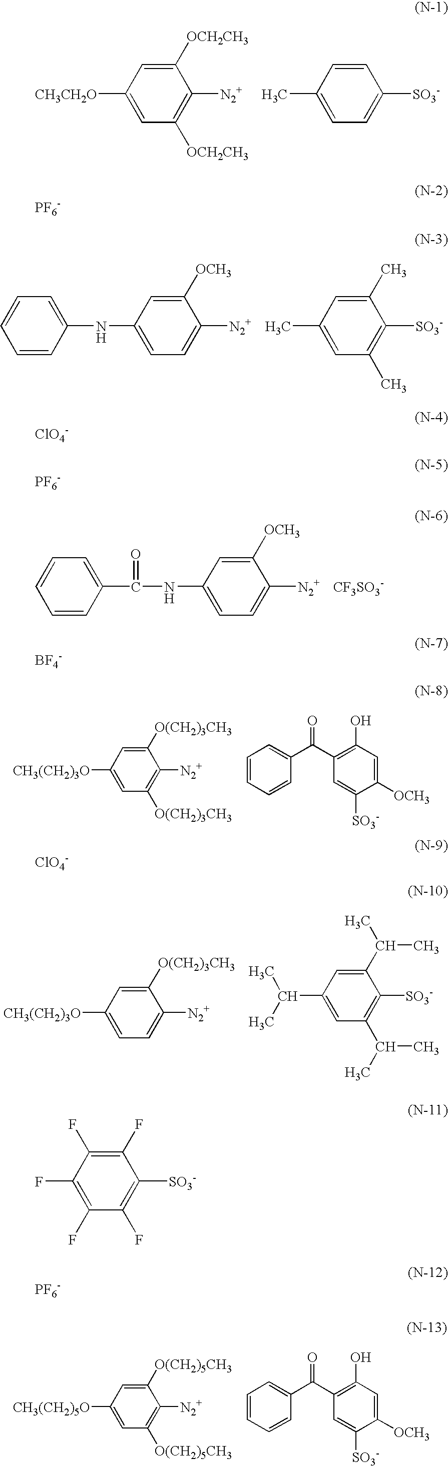

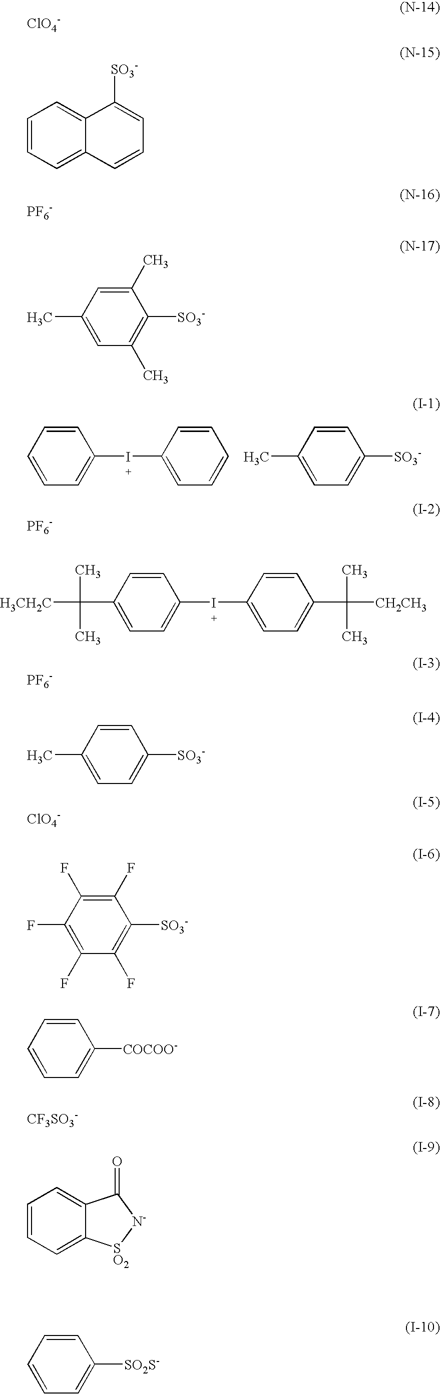

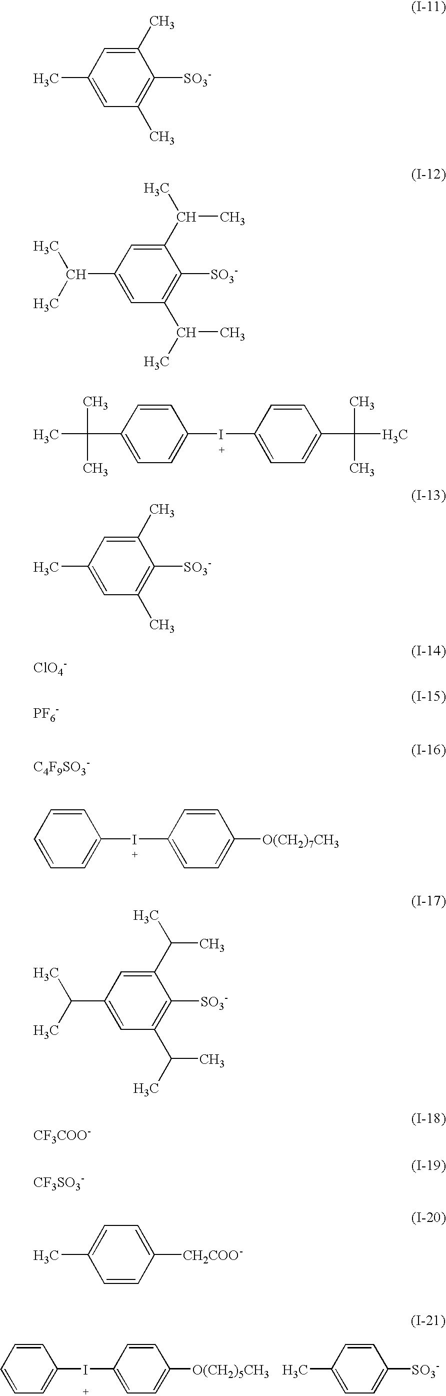

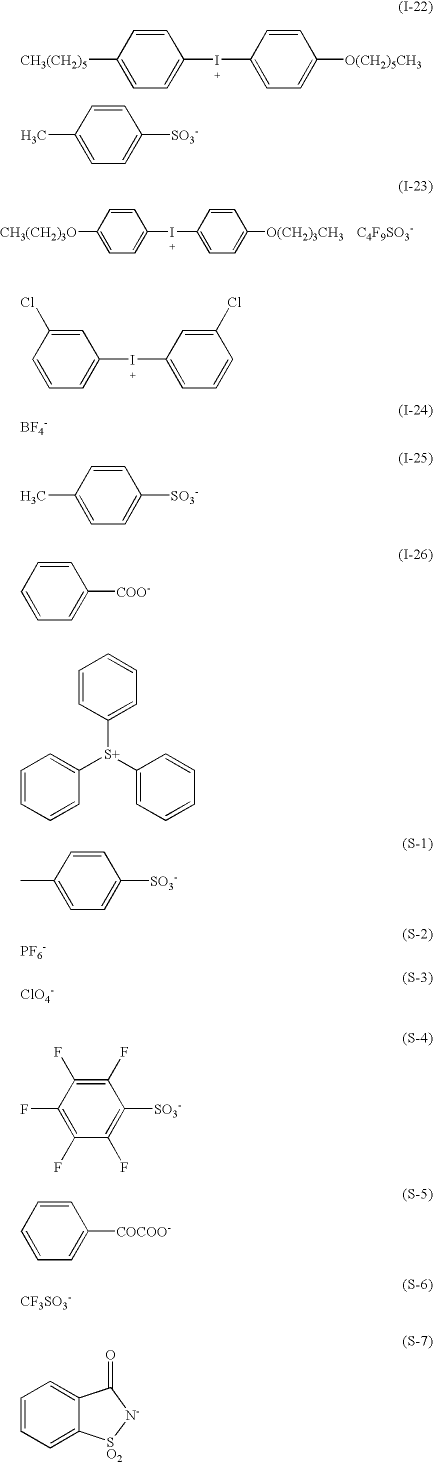

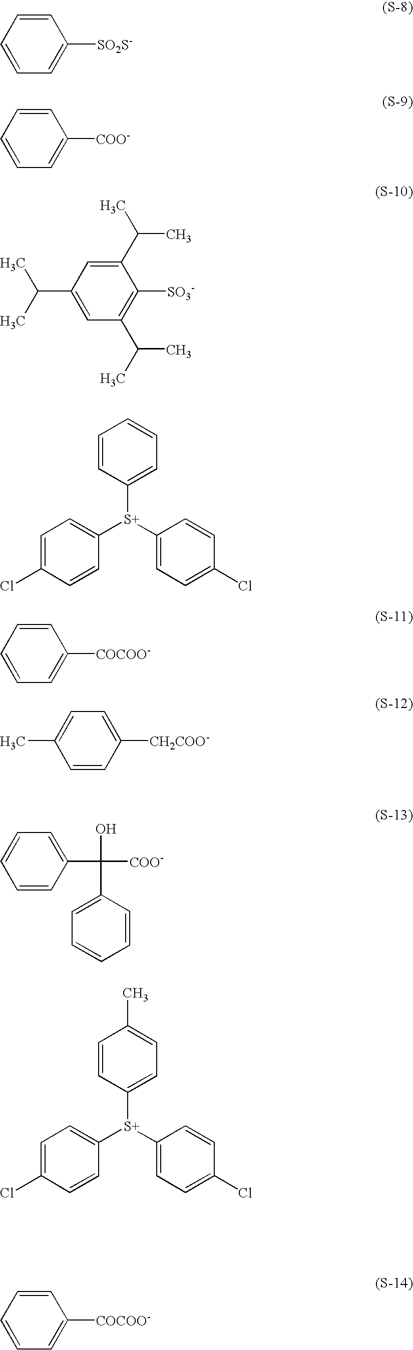

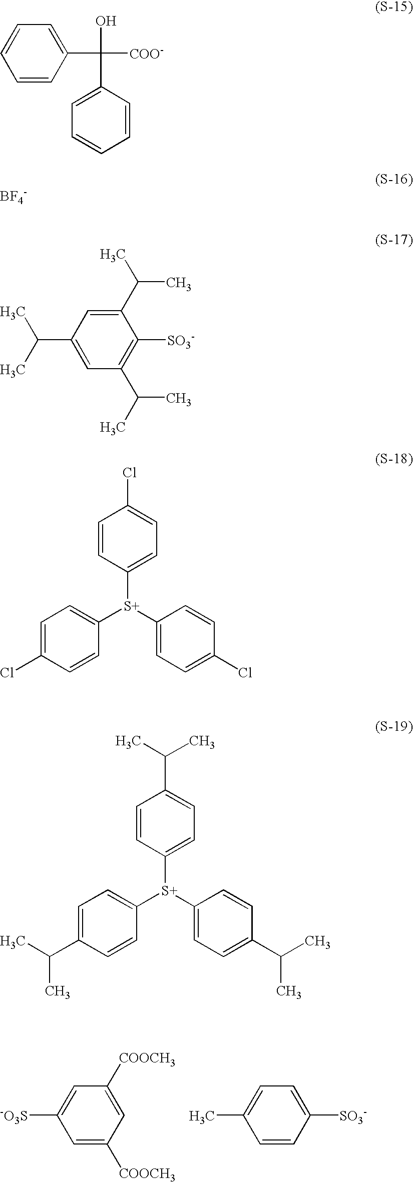

These polymerization initiators can be added preferably in an amount of from 0.1 to 50% by weight, based on the total solid content of the image-forming layer, more preferably from 0.5 to 30% by weight and particularly preferably from 1 to 20% by weight. Within the above range, a high sensitivity and favorable stain-resistance in a non-image area in the course of printing can be established. Either one of these polymerization initiators or a combination of two or more thereof may be used. Such a polymerization initiator may be added together with other components to a single layer. Alternatively, it may be added to a layer which is separately formed.

<(C) Polymerizable Compound>

The polymerizable compound used in the image-forming layer according to the invention is an addition-polymerizable compound having at least one ethylenically unsaturated double bond and it is selected from compounds having at least one, preferably two or more, terminal ethylenically unsaturated double bonds. Such compounds are broadly known in the field of art and they can be used in the invention without any particular limitation. The compound has a chemical form, for example, a monomer, a prepolymer, specifically, a dimer, a trimer or an oligomer, or a copolymer thereof, or a mixture thereof. Examples of the monomer and copolymer thereof include unsaturated carboxylic acids (for example, acrylic acid, metbacrylic acid, itaconic acid, crotonic acid, isocrotonic acid or maleic acid) and esters or amides thereof. Preferably, esters of an unsaturated carboxylic acid with an aliphatic polyhydric alcohol compound and amides of an unsaturated carboxylic acid with an aliphatic polyvalent amine compound are used. An addition reaction product of an unsaturated carboxylic acid ester or amide having a nucleophilic substituent, for example, a hydroxy group, an amino group or a mercapto group, with a monofunctional or polyfunctional isocyanate or epoxy, or a dehydration condensation reaction product of the unsaturated carboxylic acid ester or amide with a monofunctional or polyfunctional carboxylic acid is also preferably used. Furthermore, an addition reaction product of an unsaturated carboxylic acid ester or amide having an electrophilic substituent, for example, an isocyanato group or an epoxy group with a monofunctional or polyfunctional alcohol, amine or thiol, or a substitution reaction product of an unsaturated carboxylic acid ester or amide having a releasable substituent, for example, a halogen atom or a tosyloxy group with a monofunctional or polyfunctional alcohol, amine or thiol is also preferably used. In addition, compounds in which the unsaturated carboxylic acid described above is replaced by an unsaturated phosphonic acid, styrene, vinyl ether or the like can also be used.

Specific examples of the monomer, which is an ester of an aliphatic polyhydric alcohol compound with an unsaturated carboxylic acid, include acrylic acid esters, for example, ethylene glycol diacrylate, triethylene glycol diacrylate, 1,3-butanediol diacrylate, tetramethylene glycol diacrylate, propylene glycol diacrylate, neopentyl glycol diacrylate, trimethylolpropane triacrylate, trimethylolpropane tri(acryloyloxypropyl) ether, trimethylolethane triacrylate, hexanediol diacrylate, 1,4-cyclohexanediol diacrylate, tetraethylene glycol diacrylate, pentaerythritol diacrylate, pentaerythritol triacrylate, pentaerythritol tetraacrylate, dipentaerythritol diacrylate, dipentaerythritol hexaacrylate, sorbitol triacrylate, sorbitol tetraacrylate, sorbitol pentaacrylate, sorbitol hexaacrylate, tri(acryloyloxyethyl) isocyanurate, isocyanuric acid ethylene oxide (EO) modified triacrylate, polyester acrylate oligomer or isocyanuric acid EO modified triacrylate; methacrylic acid esters, for example, tetramethylene glycol dimethacrylate, triethylene glycol dimethacrylate, neopentyl glycol dimethacrylate, trimethylolpropane trimetbacrylate, trimethylolethane trimethacrylate, ethylene glycol dimethacrylate, 1,3-butanediol dimethacrylate, hexanediol dimethacrylate, pentaerythritol dimethacrylate, pentaerythritol trimethacrylate, pentaerythritol tetramethacrylate, dipentaerythritol dimethacrylate, dipentaerythritol hexamethacrylate, sorbitol trimethacrylate, sorbitol tetramethacrylate, bis[p-(3-methacryloxy-2-hydroxypropoxy)phenyl]dimethylmethane or bis[p-(methacryloxyethoxy)phenyl]dimethylmethane; itaconic acid esters, for example, ethylene glycol diitaconate, propylene glycol diitaconate, 1,3-butanediol diitaconate, 1,4-butanediol diitaconate, tetramethylene glycol diitaconate, pentaerythritol diitaconate or sorbitol tetraitaconate; crotonic acid esters, for example, ethylene glycol dicrotonate, tetramethylene glycol dicrotonate, pentaerythritol dicrotonate or sorbitol tetradicrotonate; isocrotonic acid esters, for example, ethylene glycol diisocrotonate, pentaerythritol diisocrotonate or sorbitol tetraisocrotonate, and maleic acid esters, for example, ethylene glycol dimaleate, triethylene glycol dimaleate, pentaerythritol dimaleate and sorbitol tetramaleate.

Other examples of the ester, which can be preferably used, include aliphatic alcohol esters described in JP-B-51-47334 and JP-A-57-196231, esters having an aromatic skeleton described in JP-A-59-5240, JP-A-59-5241 and JP-A-2-226149, and esters containing an amino group described in JP-A-1-165613.

The above-described ester monomers can also be used as a mixture.

Specific examples of the monomer, which is an amide of an aliphatic polyvalent amine compound with an unsaturated carboxylic acid, include methylene bisacrylamide, methylene bismethacrylamide, 1,6-hexamethylene bisacrylamide, 1,6-hexamethylene bismethacryl amide, diethylenetriamine trisacrylamide, xylylene bisacrylamide and xylylene bismethacrylamide. Other preferred examples of the amide monomer include amides having a cyclohexylene structure described in JP-B-54-21726.

Urethane type addition polymerizable compounds produced using an addition reaction between an isocyanate and a hydroxy group are also preferably used, and specific examples thereof include vinylurethane compounds having two or more polymerizable vinyl groups per molecule obtained by adding a vinyl monomer containing a hydroxy group represented by formula (II) shown below to a polyisocyanate compound having two or more isocyanate groups per molecule, described in JP-B-48-41708.
CH₂=C(R₄)COOCH₂CH(R₅)OH (II)
wherein R₄ and R₅ each independently represents H or CH₃.

Also, urethane acrylates described in JP-A-51-37193, JP-B-2-32293 and JP-B-2-16765, and urethane compounds having an ethylene oxide skeleton described in JP-B-58-49860, JP-B-56-17654, JP-B-62-39417 and JP-B-62-39418 are preferably used. Furthermore, a photopolymerizable composition having remarkably excellent photosensitive speed can be obtained by using an addition polymerizable compound having an amino structure or a sulfide structure in its molecule, described in JP-A-63-277653, JP-A-63-260909 and JP-A-1-105238.

Other examples include polyfunctional acrylates and methacrylates, for example, polyester acrylates and epoxy acrylates obtained by reacting an epoxy resin with (meth)acrylic acid, described in JP-A-48-64183, JP-B-49-43191 and JP-B-52-30490. Specific unsaturated compounds described in JP-B-46-43946, JP-B-1-40337 and JP-B-1-40336, and vinylphosphonic acid type compounds described in JP-A-2-25493 can also be exemplified. In some cases, structure containing a perfluoroalkyl group described in JP-A-61-22048 can be preferably used. Moreover, photocurable monomers or oligomers described in Nippon Secchaku Kyokaishi (Journal of Japan Adhesion Society), Vol. 20, No. 7, pages 300 to 308 (1984) can also be used.

Details of the method of using the polymerizable compound, for example, selection of the structure, individual or combination use, or an amount added, can be appropriately arranged depending on the characteristic design of the final lithographic printing plate precursor. For instance, the compound is selected from the following standpoints.

In view of the sensitivity, a structure having a large content of unsaturated groups per molecule is preferred and in many cases, a bifunctional or more functional compound is preferred. In order to increase the strength of image area, that is, hardened layer, a trifunctional or more functional compound is preferred. A combination use of compounds different in the functional number or in the kind of polymerizable group (for example, an acrylic acid ester, a methacrylic acid ester, a styrene compound or a vinyl ether compound) is an effective method for controlling both the sensitivity and the strength.

The selection and use method of the polymerizable compound are also important factors for the compatibility and dispersibility with other components (for example, a binder polymer, a polymerization initiator or a coloring agent) in the image-forming layer. For instance, the compatibility may be improved in some cases by using the compound of low purity or using two or more kinds of the compounds in combination. A specific structure may be selected for the purpose of improving an adhesion property to a support.

The polymerizable compound is preferably used in an amount from 5 to 80% by weight, more preferably from 25 to 75% by weight, based on the total solid content of the image-forming layer. The polymerizable compounds may be used individually or in combination of two or more thereof. In the method of using the polymerizable compound, the structure, blend and amount added can be appropriately selected by taking account of the extent of polymerization inhibition due to oxygen, resolution, fogging property, change in refractive index, surface adhesion and the like. Further, depending on the case, a layer construction, for example, an undercoat layer or an overcoat layer, and a coating method, may also be considered.

<(D) Binder Polymer>

In the invention, a binder polymer can bee used in order to improve the film characteristic and on-machine developing property of the image-forming layer. As the binder polymers, those heretofore known can be used without restriction, and polymers having a film forming property are preferred. Examples of the binder polymer include acrylic resins, polyvinyl acetal resins, polyurethane resins, polyurea resins, polyimide resins, polyamide resins, epoxy resins, methacrylic resins, polystyrene resins, novolac type phenolic resins, polyester resins, synthesis rubbers and natural rubbers.

The binder polymer may have a crosslinkable property in order to improve the film strength of the image area. In order to impart the crosslinkable property to the binder polymer, a crosslinkable functional group, for example, an ethylenically unsaturated bond is introduced into a main chain or side chain of the polymer. The crosslinkable functional group may be introduced by copolymerization.

Examples of the polymer having an ethylenically unsaturated bond in the main chain thereof include poly-1,4-butadiene and poly-1,4-isoprene.

Examples of the polymer having an ethylenically unsaturated bond in the side chain thereof include a polymer of an ester or amide of acrylic acid or methacrylic acid, which is a polymer wherein the ester or amide residue (R in —COOR or —CONHR) has an ethylenically unsaturated bond.

Examples of the residue (R described above) having an ethylenically unsaturated bond include —(CH₂)ₙCR¹═C²R³, —(CH₂O)ₙCH₂CR¹═CR¹ ═CR²R³, —(CH₂CH₂O)ₙCH₂CR¹═CR²R³, —(CH₂)ₙNH—CO—O—CH₂CR^{1 CR}²R³, —(CH₂)ₙ—O—CO—CR¹═CR²R³ and —(CH₂CH₂O)₂—X (wherein R¹ to R³ each represents a hydrogen atom, a halogen atom or an alkyl group having from 1 to 20 carbon atoms, an aryl group, alkoxy group or aryloxy group, or R¹ and R² or R¹ and R³ may be combined with each other to form a ring. n represents an integer of 1 to 10, X represents a dicyclopentadienyl residue).

Specific examples of the ester residue include —CH₂CH═CH₂ (described in IP-B-7-21633), —CH₂CH₂O—CH₂CH═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂ and —CH₂CH₂O—X (wherein X represents a dicyclopentadienyl residue).

Specific examples of the amide residue include —CH₂CH═CH₂, —CH₂CH₂—Y (wherein Y represents a cyclohexene residue) and —CH₂CH₂—OCO—CH═CH₂.

The binder polymer having crosslinkable property is hardened, for example, by adding a free radical (a polymerization initiating radical or a growing radical of a polymerizable compound during polymerization) to the crosslinking functional group of the polymer and undergoing addition polymerization between the polymers directly or through a polymerization chain of the polymerizable compound to form crosslinkage between the polymer molecules. Alternately, it is hardened by generation of a polymer radical upon extraction of an atom in the polymer (for example, a hydrogen atom on a carbon atom adjacent to the functional crosslinking group) by a free radial and connecting the polymer radicals with each other to form cross-linkage between the polymer molecules.

A content of the crosslinkable group in the binder polymer (content of the radical polymerizable unsaturated double bond determined by iodine titration) is preferably from 0.1 to 10.0 mmol, more preferably from 1.0 to 7.0 mmol and most preferably from 2.0 to 5.5 mmol, based on 1 g of the binder polymer. In the above-described range, preferable sensitivity and good preservation stability can be obtained.

From the standpoint of improvement in the on-machine developing property of the unexposed area in the image-forming layer, it is preferred that the binder polymer has high solubility or dispersibility in ink and/or dampening water.

In order to improve the solubility or dispersibility in the ink, the binder polymer is preferably oleophilic and in order to improve the solubility or dispersibility in the dampening water, the binder polymer is preferably hydrophilic. Therefore, it is effective in the invention that an oleophilic binder polymer and a hydrophilic binder polymer are used in combination.

The hydrophilic binder polymer preferably includes, for example, a polymer having a hydrophilic group, for example, a hydroxy group, a carboxy group, a carboxylate group, a hydroxyethyl group, a polyoxyethyl group, a hydroxypropyl group, a polyoxypropyl group, an amino group, an aminoethyl group, an aminopropyl group, an ammonium group, an amido group, a carboxymethyl group, a sulfonic acid group or a phosphoric acid group.

Specific examples thereof include gum arabic, casein, gelatin, a starch derivative, carboxy methyl cellulose and a sodium salt thereof, cellulose acetate, sodium alginate, vinyl acetate-maleic acid copolymer, styrene-maleic acid copolymer, polyacrylic acid and a salt thereof, polymethacrylic acid and a salt thereof, a homopolymer or copolymer of hydroxyethyl methacrylate, a homopolymer or copolymer of hydroxyethyl acrylate, a homopolymer or copolymer of hydroxypropyl methacrylate, a homopolymer or copolymer of hydroxypropyl acrylate, a homopolymer or copolymer of hydroxybutyl methacrylate, a homopolymer or copolymer of hydroxybutyl acrylate, a polyethylene glycol, a hydroxypropylene polymer, a polyvinyl alcohol, a hydrolyzed polyvinyl acetate having a hydrolysis degree of 60% by mole or more, preferably 80% by mole or more, a polyvinyl formal, a polyvinyl butyral, a polyvinyl pyrrolidone, a homopolymer or copolymer of acrylamide, a homopolymer or polymer of methacrylamide, a homopolymer or copolymer of N-methylolacrylamide, a polyvinyl pyrrolidone, an alcohol-soluble nylon, a polyether of 2,2-bis-(4-hydroxyphenyl)propane and epichlorohydrin.

A weight average molecular weight of the binder polymer is preferably 5,000 or more, more preferably from 10,000 to 300,000. A number average molecular weight of the binder polymer is preferably 1,000 or more, more preferably from 2,000 to 250,000. The polydispersity (weight average molecular weight/number average molecular weight) thereof is preferably from 1.1 to 10.

The content of the binder polymer is preferably from 5 to 90% by weight, more preferably from 5 to 80% by weight and more preferably from 10 to 70% by weight, based on the total solid content of the image-forming layer. In the above-described range, a high strength of the image area and favorable image-forming property can be obtained.

The ratio by weight of the polymerizable compound to the binder polymer used is preferably from 0.5/1 to 4/1.

<Fine Particle>

As a method of adding the above-described image forming-layer-constituting components (A) to (D) and other constituting components as will be described hereinafter to the image-forming layer in the invention, use can be made of several embodiments. In an embodiment, a molecule-dispersion type image forming layer is obtained by dissolving the components in an appropriate solvent and coating, as described in, for example, JP-A-2002-287334. In another embodiment, all or a part of the components are encapsulated in fine particles and contained in the image-forming layer, i.e., a fine particle type image forming layer as described in, for example, JP-A-2001-277740 and JP-A-2001-27742. The fine particle type image-forming layer may further contain component(s) outside the fine particles. In a preferred embodiment, the fine particle-type image-forming layer has hydrophobic constituting components encapsulated in the fine particles while hydrophilic constituting components outside the fine particles. To obtain improved on-machine development property, it is preferred that the image-forming layer is a fine particle-type image-forming layer.

As a method of producing the fine particles of the components (A) to (D) constituting the image-forming layer, use can be made of publicly known methods. Methods of producing the fine particle include, for example, a method of utilizing coacervation described in U.S. Pat. Nos.2,800,457 and 2,800,458, a method of using interfacial polymerization described in U.S. Pat. No. 3,287,154, JP-B-38-19574 and JP-B-42-446, a method of using deposition of polymer described in U.S. Pat. Nos. 3,418,250 and 3,660,304, a method of using an isocyanate polyol wall material described in U.S. Pat. Nos. 3,796,669, a method of using an isocyanate wall material described in U.S. Pat. No. 3,914,511, a method of using a urea-formaldehyde-type or urea-formaldehyde-resorcinol-type wall-forming material described in U.S. Pat. Nos. 4,001,140, 4,087,376 and 4,089,802, a method of using a wall material, for example, a melamine-formaldehyde resin or hydroxycellulose described in U.S. Pat. No. 4,025,445, an in-situ method by monomer polymerization described in JP-B-36-9163 and JP-B-51-9079, a spray drying method described in British Patent 930,422 and U.S. Pat. No. 3,111,407, and an electrolytic dispersion cooling method described in British Patents 952,807 and 967,074, but the invention should not be construed as being limited thereto.

A preferred fine particle wall to be used in the invention has three-dimensional crosslinkage and has a solvent-swellable property. From this point of view, a preferred wall material of the fine particle includes polyurea, polyurethane, polyester, polycarbonate, polyamide and a mixture thereof and particularly polyurea and polyurethane are preferred. Further, a compound having a crosslinkable functional group, for example, an etbylenically unsaturated bond, capable of being introduced into the binder polymer described above may be introduced into the wall of fine particle.

The average particle size of the fine particle is preferably from 0.01 to 3.0 μm, more preferably from 0.05 to 2.0 μm and particularly preferably from 0.10 to 10 to 1.0 μm. In the above-described range, preferable resolution and preservation stability can be achieved.

<Surfactant>

In the invention, it is preferred to use a surfactant in the image-forming layer in order to promote the on-machine developing property at the start of printing and to improve the state of coated surface. The surfactant includes, for example, a nonionic surfactant, an anionic surfactant, a cationic surfactant, an amphoteric surfactant and a fluorine-based surfactant. The surfactants may be used individually or in combination of two or more thereof.

The nonionic surfactant used in the invention is not particular restricted, and those hitherto known can be used. Examples of the nonionic surfactant include polyoxyethylene alkyl ethers, polyoxyethylene alkylphenylethers, polyoxyethylene polystyrylphenyl ethers, polyoxyethylene polyoxypropylene alkyl ethers, glycerin fatty acid partial esters, sorbitan fatty acid partial esters, pentaerythritol fatty acid partial esters, propylene glycol monofatty acid esters, sucrose fatty acid partial esters, polyoxyethylene sorbitan fatty acid partial esters, polyoxyethylene sorbitol fatty acid partial esters, polyethylene glycol fatty acid esters, polyglycerol fatty acid partial esters, polyoxyethylenated castor oils, polyoxyethylene glycerol fatty acid partial esters, fatty acid diethanolamides, N,N-bis-2-hydroxyalkylamines, polyoxyethylene alkylamines, triethanolamine fatty acid esters, trialylarnine oxides, polyethylene glycols, and copolymers of polyethylene glycol and polypropylene glycol.

The anionic surfactant used in the invention is not particularly restricted and those hitherto known can be used. Examples of the anionic surfactant include fatty acid salts, abietic acid salts, hydroxyalkanesulfonic acid salts, alkanesulfonic acid salts, dialkylsulfosuccinic ester salts, straight-chain alkylbenzenesulfonic acid salts, branched alkylbenzenesulfonic acid salts, alkylnaphthalenesulfonic acid salts, alkylphenoxypolyoxy ethylene propylsulfonic acid salts, polyoxyethylene alkylsulfophenyl ether salts, N-methyl-N-oleyltaurine sodium salt, N-alkylsulfosuccinic monoamide disodium salts, petroleum sulfonic acid salts, sulfated beef tallow oil, sulfate ester slats of fatty acid alkyl ester, alkyl sulfate ester salts, polyoxyethylene alkyl ether sulfate ester salts, fatty acid monoglyceride sulfate ester salts, polyoxyethylene alkyl phenyl ether sulfate ester salts, polyoxyethylene styrylphenyl ether sulfate ester salts, alkyl phosphate ester salts, polyoxyethylene alkyl ether phosphate ester salts, polyoxyethylene alkyl phenyl ether phosphate ester salts, partial saponification products of styrene/maleic anhydride copolymer, partial saponification products of olefin/maleic anhydride copolymer and naphthalene sulfonate formalin condensates.

The cationic surfactant used in the invention is not particularly restricted and those hitherto known can be used. Examples of the cationic surfactant include alkylamine salts, quaternary ammonium salts, polyoxyethylene alkyl amine salts and polyethylene polyamine derivatives.

The amphoteric surfactant used in the invention is not particularly restricted and those hitherto known can be used. Examples of the amphoteric surfactant include carboxybetaines, aminocarboxylic acids, sulfobetaines, aminosufuric esters, and imidazolines.

In the surfactants described above, the term “polyoxyethylene” can be replaced with “polyoxyalkylene”, for example, polyoxymethylene, polyoxypropylene or polyoxybutylene, and such surfactants can also be used in the invention.

Further, a preferred surfactant includes a fluorine-based surfactant containing a perfluoroalkyl group in its molecule. Examples of the fluorine-based surfactant include an anionic type, for example, perfluoroalkyl carboxylates, perfluoroalkyl sulfonates or perfluoroalkylphosphates; an amphoteric type, for example, perfluoroalkyl betaines; a cationic type, for example, perfluoroalkyl trimethyl ammonium salts; and a nonionic type, for example, perfluoroalkyl amine oxides, perfluoroalkyl ethylene oxide adducts, oligomers having a perfluoroalkyl group and a hydrophilic group, oligomers having a perfluoroalkyl group and an oleophilic group, oligomers having a perfluoroalkyl group, a hydrophilic group and an oleophilic group or urethanes having a perfluoroalkyl group and an ojeophilic group. Further, fluorine-based surfactants described in JP-A-62-170950, JP-A-62-226143 and JP-A-60-168144 are also preferably exemplified.

The surfactants may be used individually or in combination of two or more thereof.

A content of the surfactant is preferably from 0.001 to 10% by weight, more preferably from 0.01 to 5% by weight, based on the total solid content of the image-forming layer.

<Coloring Agent>

In the invention, other kinds of compounds may be added if necessary. For example, a dye having a large absorption in the visible region can be used as a coloring agent of the image formed. Specifically, the dye includes Oil yellow #101, Oil yellow #103, Oil pink #312, Oil green BG, Oil blue BOS, Oil blue #603, Oil black BY, Oil black BS, Oil black T-505 (manufactured by Orient Chemical Industries, Ltd.), Victoria pure blue, Crystal violet (CI42555), Methyl violet (CI42535), Ethyl violet, Rhodamine B (CI45170B), Malachite green (CI42000), Methylene blue (CI52015) and dyes described in JP-A-62-293247. Further, a pigment, for example, a phthalocyanine pigment, an azo pigment, carbon black or titanium oxide can also preferably be used.

It is preferred to add the coloring agent since distinction between the image area and the non-image area is easily conducted after the formation of image. An amount of the coloring agent added is preferably from 0.01 to 10% by weight based on the total solid content of the image-forming layer

<Printing-out Agent>

To the image-forming layer according to the invention, a compound causing discoloration by an acid or a radical can be added in order to form a print-out image. As such a compound, various kinds of dyes, for example, dyes of diphenylmethane type, triphenylmethane type, triazine type, oxazine type, xanthene type, anthraquinone type, iminoquinone type, azo type and azomethine type are effectively used.

Specific examples thereof include dyes, for example, Brilliant green, Ethyl violet, Methyl green, Crystal violet, basic Fuchsine, Methyl violet 2B, Quinaldine red, Rose Bengal, Methanyl yellow, Thimol sulfophthalein, Xylenol blue, Methyl orange, Paramethyl red, Congo red, Benzo purpurin 4B, α-Naphthyl red, Nile blue 2B, Nile blue A, Methyl violet, Malachite green, Parafuchsine, Victoria pure blue BOH (produced by Hodogaya Chemical Co., Ltd.), Oil blue #603 (produced by Orient Chemical Industries, Ltd.), Oil pink #312 (produced by Orient Chemical Industries, Ltd.), Oil red 5B (produced by Orient Chemical Industries, Ltd.), Oil scarlet #308 (produced by Orient Chemical Industries, Ltd.), Oil red OG (produced by Orient Chemical Industries, Ltd.), Oil red RR (produced by Orient Chemical Industries, Ltd.), Oil green #502 (produced by Orient Chemical Industries, Ltd.), Spiron Red BEH special (produced by Hodogaya Chemical Co., Ltd.), m-Cresol purple, Cresol red, Rhodamine B, rhodamine 6G, Sulfo rhodamine B, Auramine, 4-p-diethylaminophenyliminonaphthoquione, 2-carboxyanilino-4-p-diethylaminophenyliminonaphthoquinone, 2-carboxystearylamino-4-p-N,N-bis(hydroxyethyl)aminophenyliminonaphtho quinone, 1-phenyl-3-methyl-4-p-diethylaminophenylimino-5-pyrazolon or 1-β-naphtyl-4-p-diethylaminophenylimino-5-pyrazolon, and a leuco dye, for example, p, p′, p″-hexamethyltriaminotriphenylmethane (leuco crystal violet) or Pergascript Blue SRB (produced by Ciba Geigy Ltd.).

In addition to those described above, a leuco dye known as a material for heat-sensitive paper or pressure-sensitive paper is also preferably used. Specific examples thereof include crystal violet lactone, malachite green lactone, benzoyl leuco methylene blue, 2-(N-phenyl-N-methylamino)-6-(N-p-tolyl-N-ethyl)aminofluoran, 2-anilino-3-methyl-6-(n-ethyl-p-tolidino)fluoran, 3,6-dimethoxyfluoran, 3-(N,N-diethylamino)-5-methyl-7-(N,N-dibenzylamino)fluoran, 3-(N-cyclohexyl-N-methylamino)-6-methyl-7-anilinofluoran, 3-(N-N-diethylamino)-6-methyl-7-anilinofluoran, 3-(N,N-diethylamino)-6-methyl-7-xylidinofluoran, 3-(N,N-diethylamino)-6-methyl-7- chlorofluoran, 3-(N,N-diethylamino)-6-methoxy-7-aminofluoran, 3-(N,N-diethylanino)-7-(4-chloroanilino)fluoran, 3-(N,N-diethylamino)-7-chlorofluoran, 3-(N,N-diethylamino)-7-benzylaminofluoran, 3-(N,N-diethylamino)-7,8-benzofluoran, 3-(N,N-dibutylamino)-6-methyl-7-anilinofluoran, 3-(N,N-dibutylamino)-6-methyl-7-xylidinofluoran, 3-pipelidino-6-methyl-7-anilinofluoran, 3-pyrolidino-6-methyl-7-anilinofluoran, 3,3-bis(1-ethyl-2-methylindol-3-yl)phthalide, 3,3-bis(1-n-butyl-2-methylindol-3-yl)phthalide, 3,3-bis(p-dimethylaminophenyl)-6-dimethylaminophthalide, 3-(4-diethylamino-2-ethoxyphenyl)-3-(1-ethyl-2-methylindol-3-yl)-4-phthalid e and 3-(4-diethylaminophenyl)-3-(1-ethyl-2-methylindol-3-yl)phthalide.

The dye discolored by an acid or radical is preferably added in an amount of 0.01 to 10% by weight based on the solid content of the image-forming layer.

<Polymerization Inhibitor>

It is preferred to add a small amount of a thermal polymerization inhibitor to the image-forming layer according to the invention in order to prevent undesirable thermal polymerization of the polymerizable compound (C) during the production or preservation of the image-forming layer.

The thermal polymerization inhibitor preferably includes, for example, hydroquinone, p-methoxyphenol, di-tert-butyl-p-cresol, pyrogallol, tert-butyl catechol, benzoquinone, 4,4′-thiobis(3-methyl-6-tert-butylphenol), 2,2′-methylenebis(4-methyl-6-tert-butylphenol) and N-nitroso-N-phenylhydroxylamine aluminum salt.

The thermal polymerization inhibitor is preferably added in an amount of about 0.01 to about 5% by weight based on the total solid content of the image-forming layer.

<Higher Fatty Acid Derivative, and the Like>

To the image-forming layer according to the invention, a higher fatty acid derivative, for example, behenic acid or behenic acid amide may be added to localize on the surface of the image-forming layer during a drying step after coating in order to avoid polymerization inhibition due to oxygen. An amount of the higher fatty acid derivative added is preferably from about 0.1 to about 10% by weight based on the total solid content of the image-forming layer.

<Plasticizer>

The image-forming layer according to the invention may also contain a plasticizer in order to improve the on-machine developing property. The plasticizer preferably includes, for example, a phthalic acid ester, e.g., diemthylphthalate, diethylphthalate, dibutylphthalate, diisobutylphthalate, dioctylphthalate, octylcaprylphthalate, dicyclohexylphthalate, ditridecylphthalate, butylbenzylphthalate, diisodecylphthalate or diallylphthalate; a glycol ester, e.g., dimethylglycolphthalate, ehtylphtalylethylglycolate, methylphthalylethylglycolate, butylphthalylbutylglycolate or triethylene glycol dicaprylate ester; a phosphoric acid ester, e.g., tricresylphosphate or triphenylphosphate; an aliphatic dibasic acid ester, e.g., diisobutyladipate, dioctyladipate, dimethylsebacate, dibutylsebacate, dioctylazelate or dibutylmaleate; polyglycidylmethacrylate, triethyl citrate, glycerin triacetyl ester and butyl laurate.

The plasticizer is preferably added in an amount of about 30% by weight or less based on the total solid content of the image-forming layer.

<Hydrophilic Low Molecular Weight Compound>

The image-forming layer according to the invention may contain a hydrophilic low molecular weight compound in order to improve the on-machine developing property. The hydrophilic low molecular weight compound includes a water soluble organic compound, for example, a glycol compound, e.g., ethylene glycol, diethylene glycol, triethylene glycol, propylene glycol, dipropylene glycol or tripropylene glycol, or an ether or ester derivative thereof, a polyhydroxy compound, e.g., glycerine or pentaerythritol, an organic amine, e.g., triethanol amine, diethanol amine or monoethanol amine, or a salt thereof, an organic sulfonic acid, e.g., toluene sulfonic acid or benzene sulfonic acid, or a salt thereof, an organic phosphonic acid, e.g., phenyl phosphonic acid, or a salt thereof, an organic carboxylic acid, e.g., tartaric acid, oxalic acid, citric acid, maleic acid, lactic acid, gluconic acid or an amino acid, or a salt thereof.

<Microcapsule or Microgel>

As a method of adding the components constituting the image-forming layer to the image-forming layer, use can be made of several embodiments. In an embodiment, a molecule-dispersion type image-forming layer is obtained by dissolving the components in an appropriate solvent and coating, as described in, for example, JP-A-2002-287334. In another embodiment, all or a part of the components are microcapsulated and contained in the image forming layer, i.e., a microcapsule type image-forming layer as described in, for example, JP-A-2001-277740 and JP-A-2001-27742. The microcapsule type image-forming layer may further contain component(s) outside the microcapsules. In a preferred embodiment, the fine microcapsule type image-forming layer has hydrophobic constituting components encapsulated in the microcapsules while hydrophilic constituting components outside the fine particles. In another embodiment, there can be enumerated an embodiment wherein the image-forming layer contains crosslinked resin particles, i.e., a microgel. This microgel can contain a part of the constituting components in it and/or on the surface thereof. From the viewpoints of image-forming sensitivity and printing durability, an embodiment using a reactive microgel having a polymerizable compound on the surface thereof is particularly preferred.

To obtain improved on-machine development property, it is preferred that the image-forrning layer is a microcapsule type or microgel type image-forming layer.

As a method of producing the microcapsules or the microgel having the components constituting the image-forming layer, use can be made of publicly known methods.

Methods of producing the microcapsules include, for example, a method of utilizing coacervation described in U.S. Pat. Nos. 2,800,457 and 2,800,458, a method of using interfacial polymerization described in U.S. Pat. No. 3,287,154, JP-B-38-19574 and JP-B-42-446, a method of using deposition of polymer described in U.S. Pat. Nos. 3,418,250 and 3,660,304, a method of using an isocyanate polyol wall material described in U.S. Pat. No. 3,796,669, a method of using an isocyanate wall material described in U.S. Pat. No. 3,914,511, a method of using a urea-formaldehyde-type or urea-formaldehyde-resorcinol-type wall-forming material described in U.S. Pat. Nos. 4,001,140, 4,087,376 and 4,089,802, a method of using a wall material, for example, a melamine-formaldehyde resin or hydroxycellulose described in U.S. Pat. No. 4,025,445, an in-situ method by monomer polymerization described in JP-B-36-9163 and JP-B-51-9079, a spray drying method described in British Patent 930,422 and U.S. Pat. No. 3,111,407, and an electrolytic dispersion cooling method described in British Patents 952,807 and 967,074, but the invention should not be construed as being limited thereto.

A preferred microcapsule wall to be used in the invention has three-dimensional crosslinkage and has a solvent-swellable property. From this point of view, a preferred wall material of the fine particle includes polyurea, polyurethane, polyester, polycarbonate, polyamide and a mixture thereof and particularly polyurea and polyurethane are preferred. Further, a compound having a crosslinkable functional group, for example, an ethylenically unsaturated bond, capable of being introduced into the binder polymer described above may be introduced into the wall of fine particle.

On the other hand, methods of producing the microgel include, for example, use can be made of a granulation method of using interfacial polymerization described in U.S. Pat. No. 3,287,154, JP-B-38-19574 and JP-B-42-446, and a granulation method using dispersion polymerization in a non-aqueous system described in JP-A-5-61214, but the invention should not be construed as being limited thereto.

To the above-described method of using interfacial polymerization, the publicly known methods of producing microcapsules are applicable.

A preferred microgel to be used in the invention is one having been granulated by interfacial polymerization and having three-dimensional crosslinkage. From this point of view, a preferred material to be used therefor includes polyurea, polyurethane, polyester, polycarbonate, polyamide and a mixture thereof and particularly polyurea and polyurethane are preferred.

The average particle size of the microcapsule or microgel as described above is preferably from 0.01 to 3.0 μm, more preferably from 0.05 to 2.0 μm and particularly preferably from 0.10 to 1.0 μm. In the above-described range, preferable resolution and preservation stability can be achieved.

<Formation of Image-forming Layer>

The image-forming layer according to the invention is formed by dissolving or dispersing each of the necessary constituting components described above in a solvent according the manner described above to prepare a coating solution and then coating the solution. The solvent used include, for example, ethylene dichloride, cyclohexanone, methyl ethyl ketone, methanol, ethanol, propanol, ethylene glycol monomethyl ether, 1-methoxy-2-propanol, 2-methoxyethyl acetat, 1-methoxy-2-propyl acetate, dimethoxyethane, methyl lactate, ethyl lactate, N,N-dimethylacetoamide, N,N-dimethylformamide, tetramethylurea, N-methylpyrrolidone, dimethylsulfoxide, sulfolane, γ-butyrolactone, toluene and water, but the invention should not be construed as being limited thereto. The solvents may be used individually or as a mixture. The solid concentration of the coating solution is preferably from 1 to 50% by weight.

The image-forming layer according to the invention may also be formed by preparing plural coating solutions by dispersing or dissolving the same or different components described above into the same or different solvents and conducting repeatedly plural coating and drying.

A coating amount of the image-forming layer (solid content) on the support obtained after coating and drying is preferably from 0.3 to 3.0 g/m² and more preferably from 0.5 to 1.5 g/m². Within this range, a high sensitivity and favorable coating film characteristics of the image-forming layer can be obtained.

Various methods can be used for the coating. Examples of the method include bar coater coating, spin coating, spray coating, curtain coating, dip coating, air knife coating, blade coating and roll coating.

(Support)

The support for use in the lithographic printing plate precursor according to the invention is not particularly restricted as long as it is a dimensionally stable plate-like material. The support includes, for example, paper, paper laminated with plastic (for example, polyethylene, polypropylene or polystyrene), a metal plate (for example, aluminum, zinc or copper plate), a plastic film (for example, cellulose diacetate, cellulose triacetate, cellulose propionate, cellulose butyrate, cellulose acetatebutyrate, cellulose nitrate, polyethylene terephthalate, polyethylene, polystyrene, polypropylene, polycarbonate or polyvinyl acetal film) and paper or a plastic film laminated or deposited with the metal described above. A preferred support includes, a polyester film and an aluminum plate. Among them, the aluminum plate is preferred since it has good dimensional stability and is relatively inexpensive.

The aluminum plate includes a pure aluminum plate, an alloy plate comprising aluminum as a main component and containing a trace amount of hetero elements and a thin film of aluminum or aluminum alloy laminated with plastic. The hetero element contained in the aluminum alloy includes, for example, silicon, iron, manganese, copper, magnesium, chromium, zinc, bismuth, nickel and titanium. The content of the hetero element in the aluminum alloy is preferably 10% by weight or less. Although a pure aluminum plate is preferred in the invention, since completely pure aluminum is difficult to be produced in view of the refining technique, the aluminum plate may slightly contain the hetero element. The composition is not specified for the aluminum plate and those materials conventionally known and used can be appropriately utilized.

The thickness of the support is preferably from 0.1 to 0.6 mm, more preferably from 0.15 to 0.4 mm, and still more preferably from 0.2 to 0.3 mm.

Prior to the use of aluminum plate, a surface treatment, for example, roughening treatment or anodizing treatment is preferably performed. The surface treatment facilitates improvement in the hydrophilic property and ensure for adhesion between the image-forming layer and the support. Prior to the roughening treatment of the aluminum plate, a degreasing treatment, for example, with a surfactant, an organic solvent or an aqueous alkaline solution is conducted for removing rolling oil on the surface htereof, if desired.

The roughening treatment of the surface of the aluminum plate is conducted by various methods and includes, for example, mechanical roughening treatment, electrochemical roughening treatment (roughening treatment of electrochemically dissolving the surface) and chemical roughening treatment (roughening treatment of chemically dissolving the surface selectively).

As the method of the mechanical roughening treatment, a known method, for example, ball grinding, brush grinding, blast grinding or buff grinding can be used.

The electrochemical roughening treatment method includes, for example, a method of conducting by passing alternating current or direct current in an electrolyte containing an acid, for example, hydrochloric acid or nitric acid. Also, a method of using a mixed acid described in JP-A-54-63902 can be used.

The aluminum plate subjected to the roughening treatment is subjected, if desired, to an alkali etching treatment using an aqueous solution, for example, of potassium hydroxide or sodium hydroxide and further subjected to a neutralizing treatment, and then subjected to an anodizing treatment for improving the abrasion resistance, if desired.

As the electrolyte used for the anodizing treatment of the aluminum plate, various electrolytes capable of forming porous oxide film can be used. Ordinarily, sulfuric acid, hydrochloric acid, oxalic acid, chromic acid or a mixed acid thereof is used. The concentration of the electrolyte can be appropriately determined depending on the kind of the electrolyte.

Since the conditions for the anodizing treatment are varied depending on the electrolyte used, they cannot be defined commonly. However, it is ordinarily preferred that electrolyte concentration in the solution is from 1 to 80% by weight, liquid temperature is from 5 to 70° C., current density is from 5 to 60 A/dm², voltage is from 1 to 100 V, and electrolysis time is from 10 seconds to 5 minutes. The amount of the anodized film formed is preferably from 1.0 to 5.0 g/m² and more preferably from 1.5 to 4.0 g/m². In the above-described range, good printing durability and good scratch resistance in the non-image area of lithographic printing plate can be achieved,

As the support to be used in the present invention, use may be made of a substrate as such, i.e., having been subjected to the above-described surface treatment and being provided with an anodic oxidation film. To further improve the adhesion to the upper layer, hydrophilic nature, stain-resistance, heat-insulating properties and so on, it can be optionally subjected to a treatment selected from among a treatment for enlarging micropores in the anodic oxidation film, a treatment for clogging the micropores, a surface-hydrophilization treatment by soaking in an aqueous solution containing a hydrophilic compound and so on, as described in JP-A-2001-253181 and JP-A-2001-322365. Needless to say, treatments for enlarging or clogging micropores are not restricted to those described in the above documents but any one of publicly known methods is usable.

To clog micropores, for example, use can be made of a steam clogging treatment, a treatment using fluorozirconic acid, a treatment with sodium fluoride or a steam treatment with the use of lithium chloride.

In the invention, any treatment can be employed for clogging micropores without restriction. namely, use can be made of publicly known methods therefor. In particular, it is preferable to employ a treatment of clogging micropores by using an aqueous solution containing an inorganic fluorine compound, a clogging treatment by using steam and a clogging treatment by using hot water. Next, these methods will be described.

As the inorganic fluorine compound to be used in the treatment of clogging micropores by using an aqueous solution containing an inorganic fluorine compound, metal fluorides can be preferably cited.

As specific examples thereof, there can be enumerated sodium fluoride, potassium fluoride, calcium fluoride, magnesium fluoride, sodium fluorozirconate, potassium fluorozirconate, sodium fluorotitanate, potassium fluorotitanate, ammonium fluorozirconate, ammonium fluorotitanate, fluorozirconic acid, fluorotitanic acid, hexafluorosilicic acid, nickel fluoride, iron fluoride, fluorophosphoric acid and ammonium fluorophosphate. Among all, sodium fluorozirconate, sodium fluorotitanate, fluorozirconic acid and fluorotitanic acid are preferred.

From the viewpoint of sufficiently clogging micropores in the anodic oxidation film, the concentration of the inorganic fluorine compound in the aqueous solution is preferably 0.01% by weight or more and more preferably 0.05% by weight or more. From the viewpoint of stain resistance, the concentration is preferably 1% by weight or less, more preferably 0.5% by weight or less.

It is preferred that the aqueous solution containing an inorganic fluorine compound further contains a phosphate compound. By adding the phosphate compound, the surface hydrophilic nature of the anodic oxidation film can be enhanced and thus the on-machine development property and stain resistance can be improved.

As the phosphate compound, there can be appropriately enumerated phosphoric acid salts of alkali metals and alkaline earth metals.

More specifically speaking, there can be enumerated zinc phosphate, aluminum phosphate, ammonium phosphate, diammonium hydrogenphosphate, ammonium dihydrogeaphosphate, monoammonium phosphate, monopotassium phosphate, monosodium phosphate, potassium dihydrogenphosphate, dipotassium hydrogenphosphate, calcium phosphate, ammonium sodium hydrogenphosphate, magnesium hydrogenphosphate, magnesium phosphate, ferrous phosphate, ferric phosphate, sodium dihydrogenphosphate, sodium phosphate, disodium hydrogenphosphate, lead phosphate, diammonium phosphate, calcium dihydrogenphosphate, lithium phosphate, phosphotungstic acid, ammonium phosphotungstate, sodium phosphotungstate, ammonium phosphomolybdate, sodium phosphomolybdate, sodium phosphite, sodium tripolyphosphate and sodium pyrophosphate. Among all, sodium dihydrogenphosphate, disodium hydrogenphosphate, potassium dihydrogenphoshate an dipotassium hydrogenphosphate are preferred.

Although the combination of the inorganic fluorine compound with the phosphate compound is not particularly restricted, it is preferred that the aqueous solution contains at least sodium fluorozirconate as the inorganic fluorine compound and a least sodium dihydrogenphosphate as the phosphate compound.

From the viewpoints of on-machine development property and stain resistance, it is preferred that the concentration of the phosphate compound in the aqueous solution is preferably 0.01% by weight or more and more preferably 0.1% by weight or more. From the viewpoint solubility, the concentration is preferably 20% by weight or less, more preferably 5% by weight or less.

Although the ratio of individual compounds in the aqueous solution is not particularly restricted, it is preferred that the ratio by weight of the inorganic fluorine compound to the phosphate compound ranges from 1/200 to 10/1, more preferably from 1/30 to 2/1.

The temperature of the aqueous solution is preferably 20° C. or higher, more preferably 40° C. or higher but not more than 100° C. and more preferably not more than 80° C.

The pH value of the aqueous solution is preferably pH 1 or more and more preferably pH 2 or more but not more than pH 11 and more preferably not more than pH 5.

The method of the clogging treatment with the use of the aqueous solution containing the inorganic fluorine compound is not particularly restricted. For example, use can be made of the immersion method or the spraying method. A single treatment may be conducted once or more. Alternatively, two or more treatments may be combined together.

Among all, the immersion method is preferred. In the case of treating by the immersion method, the treatment time is preferably 1 second or longer and more preferably 3 seconds or longer but not longer than 100 seconds and more preferably not longer than 20 seconds.

The steam clogging treatment may be conducted by, for example, continuously or discontinuously contacting the anodic oxidation film with steam under atmospheric pressure or elevated pressure.

The steam temperature is preferably 80° C. or higher and more preferably 95° C. or higher but not higher than 105° C.

The steam pressure preferably ranges from (atmospheric pressure−50 mmAq) to (atmospheric pressure+300 mmAq), i.e., from 1.008×10⁵ to 1.043×10⁵ Pa.

The contact time with the steam is preferably 1 second or longer and more preferably 3 seconds or longer but not longer than 100 seconds and more preferably not longer than 20 seconds.

The hot water clogging treatment may be conducted by, for example, immersing an aluminum plate having an anodic oxidation film formed thereon in hot water.

The hot water may contain an inorganic salt (for example, a phosphate) or an organic salt.

The temperature of the hot water is preferably 80° C. or higher and more preferably 95° C. or higher but not higher than 100° C.

The immersion time in the hot water is preferably 1 second or longer and more preferably 3 seconds or longer but not longer than 100 seconds and more preferably not longer than 20 seconds.

In the invention, it is possible to perform a treatment for enlarging the micropores in the anodic oxidation film as described in JP-A-2001-322365 prior to the clogging treatment as discussed above. Moreover, a hydrophilizing treatment on the surface may be performed after the clogging.

The hydrophilizing treatment includes an alkali metal silicate method described in U.S. Pat. Nos.2,714,066, 3,181,461, 3,280,734 and 3,902,734. In the method, the support is subjected to immersion treatment or electrolytic treatment in an aqueous solution, for example, of sodium silicate. In addition, the hydrophilizing treatment includes, for example, a method of treating with potassium fluorozirconate as described in JP-B-36-22063 and a method of treating with polyvinylphosphonic acid as described in U.S. Pat. Nos. 3,276,868, 4,153,461 and 4,689,272.

In the case of using a support having insufficient hydrophilicity, for example, a polyester film, in the invention, it is desirable to coat a hydrophilic layer thereon to make the surface sufficiently hydrophilic. The hydrophilic layer preferably used includes a hydrophilic layer formed by coating a coating solution containing a colloid of an oxide or hydroxide of at least one element selected from beryllium, magnesium, aluminum, silicon, titanium, boron, germanium, tin, zirconium, iron, vanadium, antimony and a transition metal as described in JP-A-2001-199175, a hydrophilic layer containing an organic hydrophilic matrix obtained by crosslinking or pseudo-crosslinking of an organic hydrophilic polymer as described in JP-A-2002-79772, a hydrophilic layer containing an inorganic hydrophilic matrix obtained by sol-gel conversion comprising hydrolysis and condensation reaction of polyalkoxysilane and titanate, zirconate or aluminate and a hydrophilic layer comprising an inorganic thin layer having a surface containing metal oxide. Among them, the hydrophilic layer formed by coating a coating solution containing a colloid of an oxide or hydroxide of silicon is preferred.

Further, in the case of using, for example, a polyester film as the support in the invention, it is preferred to provide an antistatic layer on the hydrophilic layer side, the opposite side to the hydrophilic layer or both sides. In the case where the antistatic layer is provided between the support and the hydrophilic layer, it also contributes to improve the adhesion of the hydrophilic layer to the support. As the antistatic layer, a polymer layer having fine particles of metal oxide or a matting agent dispersed therein as described in JP-A-2002-79772 may be used.

The support of the invention preferably has a center line average roughness of from 0.10 to 1.2 μm. In the above-described range, good adhesion with the image-forming layer, good printing durability, and good resistance to stain can be achieved.

[Back Coat Layer]

After applying the surface treatment or forming the undercoat layer to the support, a back coat layer can be provided on the back surface of the support, if desired.

The back coat layer preferably used includes, for example, a coating layer comprising an organic polymer compound as described in JP-A-5-45885 and a coating layer comprising a metal oxide obtained by hydrolysis and polycondensation of an organic metal compound or an inorganic metal compound as described in JP-A-6-35174. Among them, use of an alkoxy compound of silicon, for example, Si(OCH₃)₄, Si(OC₂H₅)₄, Si(OC₃H₇)₄, or Si(OC₄H₉)₄ is preferred since the starting material is inexpensive and easily available.

(Undercoat Layer)

In the lithographic printing plate precursor according to the invention, particularly in the lithographic printing plate precursor of on-machine development type, an undercoat layer is provided between the support and the image-forming layer, if desired. The undercoat layer makes removal of the image-forming layer from the support in the unexposed area easy so that the on-machine development property can be improved. Further, it is advantageous that in the case of infrared laser exposure, since the undercoat layer acts as a heat insulating layer, heat generated upon the exposure does not diffuse into the support and is efficiently utilized so that increase in sensitivity can be achieved.

As a compound (undercoat compound) for the undercoat layer, specifically, for example, a silane coupling agent having an addition-polymerizable ethylenic double bond reactive group described in JP-A-10-282679 and a phosphorus compound having an ethylenic double bond reactive group described in JP-A-2-304441 are preferably exemplified.

As the most preferred compound for undercoat layer, a polymer resin obtained by copolymerization of a monomer having a support-adsorbing group, a monomer having a hydrophilic group and a monomer having a crosslinkable group is exemplified.

The essential component in the polymer resin for the undercoat layer is a support-adsorbing group (an adsorbing group to the hydrophilic surface of the support). Whether adsorptivity to the hydrophilic surface of the support is present or not can be judged, for example, by the following method.

A test compound is dissolved in an easily soluble solvent to prepare a coating solution, and the coating solution is coated and dried on a support so as to have the coating amount after drying of 30 mg/m². After thoroughly washing the support coated with the test compound using the easily soluble solvent, the residual amount of the test compound that has not been removed by the washing is measured to calculate the adsorption amount to the support. For measuring the residual amount, the residual amount of the test compound may be directly determined, or may be calculated by determining the amount of the test compound dissolved in the washing solution. The determination for the compound can be performed, for example, by X-ray fluorescence spectrometry, reflection absorption spectrometry or liquid chromatography. The compound having the adsorptivity to support is a compound that remains by 1 mg/m² or more even after conducting the washing treatment described above.

The adsorbing group to the hydrophilic surface of the support is a functional group capable of forming a chemical bond (for example, an ionic bond, a hydrogen bond, a coordinate bond or a bond with intermolecular force) with a substance (for example, metal or metal oxide) or a functional group (for example, a hydroxy group) present on the surface of the support. The adsorbing group is preferably an acid group or a cationic group.

The acid group preferably has an acid dissociation constant (pKa) of 7 or less. Examples of the acid group include a phenolic hydroxy group, a carboxyl group, —SO₃H, —OSO₃H, —PO₃H₂, —OPO₃H₂, —CONHSO₂—, —SO₂NHSO₂— and —COCH₂COCH₃. Among them, —OP0₃H₂ and —PO₃H₂ are particularly preferred. The acid group may be the form of a metal salt.

The cationic group is preferably an onium group. Examples of the onium group include an ammonium group, a phosphonium group, an arsonium group, a stibonium group, an oxonium group, a sulfonium group, a selenonium group, a stannonium group and iodonium group. Among them, the ammonium group, phosphonium group and sulfonium group are preferred, the ammonium group and phosphonium group are more preferred, and the ammonium group is most preferred.

Particularly preferred examples of the monomer having the adsorbing group include compounds represented by the following formula (III) or (IV):

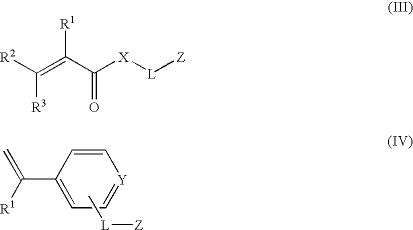

In formula (III) or (IV), R¹, R² and R³ each independently represents a hydrogen atom, halogen atom or an alkyl group having from 1 to 6 carbon atoms. R¹ and R² and R³ each independently represents preferably a hydrogen atom or an alkyl group having from 1 to 6 carbon atoms, more preferably a hydrogen atom or an alkyl group having from 1 to 3 carbon atoms and, most preferably a hydrogen atom or methyl. It is particularly preferred that R² and R³ each represents a hydrogen atom.

In the formula (III), X represents an oxygen atom (—O—) or imino group (—NH—). Preferably, X represents an oxygen atom. In the formula (III) or (IV), L represents a divalent connecting group. It is preferred that L represents a divalent aliphatic group (for example, an alkylene group, a substituted alkylene group, an alkenylene group, a substituted alkenylene group, an alkinylene group or a substituted alkinylene group), a divalent aromatic group (for example, an arylene group or a substituted arylene group), a divalent heterocyclic group or a combination of each of the groups described above with an oxygen atom (—O—), a sulfur atom (—S—), an imino group (—NH—), a substituted imino group (—NR—, where R represents an aliphatic group, an aromatic group or a heterocyclic group) or a carbonyl group (—CO—).

The aliphatic group may form a cyclic structure or a branched structure. The number of carbon atoms of the aliphatic group is preferably from 1 to 20, more preferably from 1 to 15, and most preferably from 1 to 10. It is preferred that the aliphatic group is a saturated aliphatic group rather than an unsaturated aliphatic group. The aliphatic group may have a substituent. Examples of the substituent include a halogen atom, a hydroxy group, an aromatic group and a heterocyclic group.

The number of carbon atoms of the aromatic group is preferably from 6 to 20, more preferably from 6 to 15 and most preferably from 6 to 10. The aromatic group may have a substituent. Examples of the substituent include a halogen atom, a hydroxy group, an aliphatic group, an aromatic group and a heterocyclic group.

It is preferred that the heterocyclic group has a 5-membered or 6-membered ring as the hetero ring. Other heterocyclic ring, an aliphatic group or an aromatic ring may be condensed to the heterocyclic ring. The heterocyclic group may have a substituent. Examples of the substituent include a halogen atom, a hydroxy group, an oxo group (═O), a thio group (═S), an imino group (═NH), a substituted imino group (═N—R, where R represents an aliphatic group, an aromatic group or a heterocyclic group), an aliphatic group, an aromatic group and a heterocyclic group.

It is preferred that L represents a divalent connecting group containing a plurality of polyoxyalkylene structures. It is more preferred that the polyoxyalkylene structure is a polyoxyethylene structure. Specifically, it is preferred that L contains —(OCH₂CH₂)ₙ— (n is an integer of 2 or more).

In the formula (III) or (IV), Z represents a functional group adsorbing to the hydrophilic surface of the support. Y represents a carbon atom or a nitrogen atom. In the case where Y is a nitrogen atom and L is connected to Y to form a quaternary pyridinium group, Z is not mandatory, because the quaternary pyridinium group itself exhibits the adsorptivity.

Representative examples of the monomer represented by formula (III) or (IV) are set forth below.

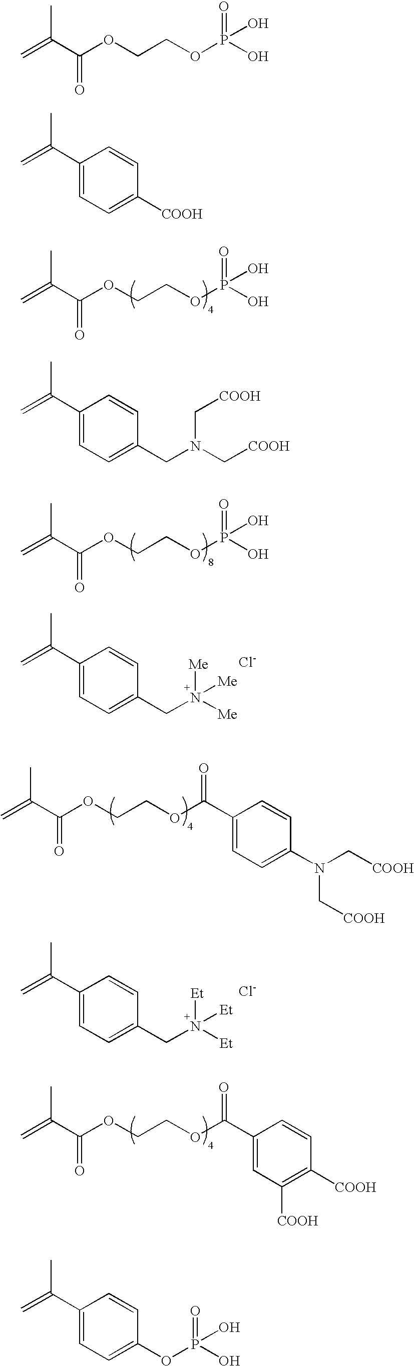

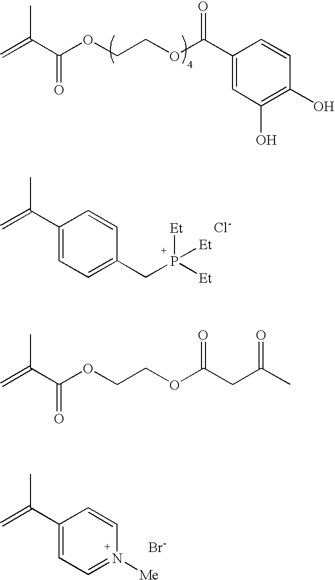

The hydrophilic group included in the polymer resin for the undercoat layer use in the invention preferably includes, for example, a hydroxy group, a carboxyl group, a carboxylate group, a hydroxyethyl group, a polyoxyethyl group, a hydroxypropyl group, a polyoxypropyl group, an amino group, an aminoethyl group, an aminopropyl group, an ammonium group, an amido group, a carboxymethyl group, a sulfonic acid group and a phosphoric acid group. Among them, a monomer having a sulfonic acid group exhibiting a highly hydrophilic property is preferable. Specific examples of the monomer having a sulfonic acid group include sodium salt or an amine salt of methacryloxybenzenesulfonic acid, acryloxybenzenesulfonic acid, allylsulfonic acid, vinylsulfonic acid, allylsulfonic acid, p-styrenesulfonic acid, methacrylsulfonic acid, acrylamido-tert-butylsulfonic acid, 2-acrylamido-2-methylpropanesulfonic acid and (3-acryloyloxypropyl)buthylsulfonic acid. Among them, from the standpoint of the hydrophilic property and handling property in the synthesis thereof, sodium salt of 2-acrylamido-2-methylpropanesulfonic acid is preferable.

It is preferred that the water-soluble polymer resin for the undercoat layer according to the invention has a crosslinkable group. The crosslinkable group acts to improve the adhesion to the image area. In order to impart the crosslinking property to the polymer resin for the undercoat layer, introduction of a crosslinking functional group, for example, an ethylenically unsaturated bond into the side chain of the polymer, or introduction by formation of a salt structure between a polar substituent of the polymer resin and a compound containing a substituent having a counter charge to the polar substituent of the polymer resin and an ethylenically unsaturated bond is used Examples of the polymer having an ethylenically unsaturated bond in the side chain thereof include a polymer of an ester or amide of acrylic acid or methacrylic acid, which is a polymer wherein the ester or amide residue (R in —COOR or —CONHR) has an ethylenically unsaturated bond.

Examples of the residue (R described above) having an ethylenically unsaturated bond include —(CH₂)ₙCR₁═CR₂R₃, —(CH₂O)ₙCH₂CR_{1═CR}₂ R₃, —(CH₂CH₂O)ₙCH₂CR₁═CR₂R₃, —(CH₂)ₙNH—CO—O—CH₂CR₁═CR₂R₃, —(CH₂)ₙ—O—CO—CR₁═CR₂R₃ and —(CH₂CH₂O)₂—X (wherein R₁ to R₃ each independently represents a hydrogen atom, a halogen atom or an alkyl group having from 1 to 20 carbon atoms, an aryl group, alkoxy group or aryloxy group, or R₁ and R₂ or R₁ and R₃ may be combined with each other to form a ring. n represents an integer of 1 to 10. X represents a dicyclopentadienyl residue).

Specific examples of the ester residue include —CH₂CH═CH₂ (described in JP-B-7-21633) —CH₂CH₂O—CH₂CH═CH₂, —CH₂C(CH₃)═CH₂, —CH₂CH═CH—C₆H₅, —CH₂CH₂OCOCH═CH—C₆H₅, —CH₂CH₂—NHCOO—CH₂CH═CH₂ and —CH₂CH₂O—X (wherein X represents a dicyclopentadienyl residue).

Specific examples of the amide residue include —CH₂CH═CH₂, —CH₂CH₂O—Y (wherein Y represents a cyclohexene residue) and —CH₂CH₂OCO —CH═CH₂.

As a monomer having a crosslinkable group for the polymer resin for undercoat layer, an ester or amide of acrylic acid or methacrylic acid having the crosslinkable group is preferred.

A content of the crosslinking group in the polymer resin for undercoat layer (content of the radical polymerizable unsaturated double bond determined by iodine titration) is preferably from 0.1 to 10.0 mmol, more preferably from 1.0 to 7.0 mmol and most preferably from 2.0 to 5.5 mmol, based on 1 g of the polymer resin. In the above-described range, preferable compatibility between the sensitivity and stain resistance and good preservation stability can be obtained.

A weight average molecular weight of the polymer resin for undercoat layer is preferably 5,000 or more, more preferably from 10,000 to 300,000. A number average molecular weight of the polymer resin is preferably 1,000 or more, more preferably from 2,000 to 250,000. Polydispersity (weight average molecular weight/number average molecular weight) thereof is preferably from 1.1 to 10.

The polymer resin for undercoat layer may be any of a random polymer, a block polymer, a graft polymer and the like, and preferably a random polymer.

The polymer resins for undercoat layer may be used individually or in a mixture of two or more thereof.

A coating amount (solid content) of the undercoat layer is preferably from 0.1 to 100 mg/m², and more preferably from 1 to 30 mg/m².

It is a particularly preferable embodiment that the compound having a polymerizable group also has an adsorbing group to support and a hydrophilicity-imparting group in the molecule thereof in view of further improvement in the adhesion, the on-machine developing property and stain resistance. The term “adsorbing group to support” as used herein means a group capable of ordinarily forming an ionic bond, a hydrogen bond, a coordinate bond or a bond with intermolecular force with metal, a metal oxide, a hydroxy group or the like present on the support subjected to the anodizing treatment or hydrophilizing treatment. As the adsorbing group to support, an acid group or an onium group is preferable. As the acid group, an acid group having an acid dissociation constant (pKa) of 7 or less is preferable. Specific examples of the acid group include —COOH, —SO₃H, —OSO₃H, —PO₃H₂, —OPO₃H₂, —CONHSO₂— and —SO₂NHSO₂—. Among them, —PO₃H₂ is particularly preferred. As the onium group, an onium group formed from an atom belonging to Group 5B (Group 15) or Group 6B (Group 16) of the periodic table is preferable, an onium group formed from a nitrogen atom, a phosphorus atom or a sulfur atom is more preferable, and an onium group formed from a nitrogen atom is particularly preferable. As the hydrophilicity-imparting group, for example, an ethyleneoxide group (—OCH₂CH₂—) and a sulfonic acid group are exemplified.

A coating amount (solid content) of the undercoat layer is preferably from 0.1 to 100 mg/M², and more preferably from 3 to 30 mg/M².

[Lithographic Printing Method]

In the lithographic printing method according to the invention, the lithographic printing plate precursor as described above is exposed imagewise with a laser.

The laser is particularly preferred and includes, for example, a solid laser and a semiconductor laser emitting an infrared ray having a wavelength of 760 to 1,200 nm, though the invention is not restricted thereto. It is preferred that the output of the infrared laser is 100 mW or more. Also, in order to shorten the exposure time, it is preferred to use a multibeam laser device.

The exposure time per pixel is preferably within 20 μs. Also, the irradiation energy is preferably from 10 to 300 mJ/cm².

In the lithographic printing method of the invention, the lithographic printing plate precursor according to the invention is imagewise exposed by a laser beam and then subjected to printing by supplying oily ink and an aqueous component without undergoing any development processing step, as discussed above.

Specifically, for instance, a method wherein the lithographic printing plate precursor is exposed by a laser beam and mounted on a printing machine to perform printing without undergoing the development processing step, and a method wherein the lithographic printing plate precursor is mounted on a printing machine, exposed by a laser beam on the printing machine and then subjected to printing without undergoing the development processing step are exemplified.

After imagewise exposure of the lithographic printing plate precursor by a laser beam, when the aqueous component and oily ink are supplied to perform printing without undergoing the development processing step, for example, a wet development processing step, the image-forming layer hardened by the exposure forms the oily ink-receptive area having an oleophilic surface in the exposed area of the image-forming layer. On the other hand, in the unexposed area, the unhardened image-forming layer is removed by dissolution or dispersion with the aqueous component and/or oily ink supplied to reveal a hydrophilic surface in the area.

As a result, the aqueous component is adhered on the revealed hydrophilic surface and the oily ink is deposited on the image-forming layer in the exposed area and printing is initiated While either the aqueous component or the oily ink may be supplied at first to the plate surface, it is preferred to supply the oily ink at first for preventing the aqueous component from contamination with the image-forming layer in the unexposed area. As the aqueous component and oily ink, dampening water and printing ink for conventional lithographic printing are respectively used.

Thus, the lithographic printing plate precursor is subjected to the on-machine development on an offset printing machine and used as it is for printing a large number of sheets.

### EXAMPLES

The present invention will be described in more detail with reference to the following examples, but the invention should not be construed as being limited thereto.

(Preparation of Support A)

An aluminum plate (material: JIS 1050) having a thickness of 0.3 mm was subjected to a degreasing treatment at 50° C. for 30 seconds using a 10% by weight aqueous sodium aluminate solution in order to remove rolling oil on the surface thereof and then grained the surface thereof using three nylon brushes embedded with bundles of nylon bristle having a diameter of 0.3 mm and an aqueous suspension (specific gravity: 1.1 g/cm³) of pumice having a median size of 25 μm, followed by thorough washing with water. The plate was etched by immersing in a 25% by weight aqueous sodium hydroxide solution of 45° C. for 9 seconds, washed with water, then immersed in a 20% by weight nitric acid at 60° C. for 20 seconds, and washed with water. The etching amount of the grained surface was about 3 g/m².

Then, using an alternating current of 60 Hz, an electrochemical roughening treatment was continuously carried out on the plate. The electrolyte used was a 1% by weight aqueous nitric acid solution (containing 0.5% by weight of aluminum ion) and the electrolyte temperature was 50° C. The electrochemical roughening treatment was conducted using an alternating current source, which provides a rectangular alternating current having a trapezoidal waveform such that the time TP necessary for the current value to reach the peak from zero was 0.8 msec and the duty ratio was 1:1, and using a carbon electrode as a counter electrode. A ferrite was used as an auxiliary anode. The current density was 30 A/dm² in terms of the peak value of the electric current, and 5% of the electric current flowing from the electric source was divided to the auxiliary anode. The quantity of electricity in the nitric acid electrolysis was 175 C/dm² in terms of the quantity of electricity when the aluminum plate functioned as an anode. The plate was then washed with water by spraying.

The plate was further subjected to an electrochemical roughening treatment in the same manner as in the nitric acid electrolysis above using as an electrolyte, a 0.5% by weight aqueous hydrochloric acid solution (containing 0.5% by weight of aluminum ion) having temperature of 50° C. and under the condition that the quantity of electricity was 50 C/dm² in terms of the quantity of electricity when the aluminum plate functioned as an anode. The plate was then washed with water by spraying. The plate was subjected to an anodizing treatment using as an electrolyte, a 15% by weight sulfuric acid (containing 0.5% by weight of aluminum ion) at a current density of 15 A/dM² to form a direct current anodic oxidation film of 2.5 g/m², washed with water and dried to obtain Support A. The center line average roughness (Ra) of the support was measured using a stylus having a diameter of 2 μm and it was found to be 0.51 μm.

(Preparation of Support B)

A support having an anodic oxidation film, which had prepared as in Support A as described above, was immersed in a solution (pH 3.7) containing 0.1% by weight of sodium fluorozirconate and 1% by weight of sodium dihydrogenphosphate and heated to 75° C. for 10 seconds to thereby clog micropores. Next, it was treated with a 2.5% by weight aqueous solution of sodium silicate at 30° C. for 10 seconds. The center line average roughness (Ra) of the support was measured using a stylus having a diameter of 2 μm and it was found to be 0.51 μm.

### Example 1

Undercoat solution (1) shown below was bar-coated on Support B described above so as to have a dry coating amount of 10 mg/m². Next, it was dried in an oven at 80° C. for 20 seconds to form an undercoat layer. On the undercoat layer thus formed, a coating solution (1) for image-forming layer was bar-coated and dried in an oven at 100° C. for 60 seconds to form an image-forming layer having a dry coating amount of 1.0 g/m². Thus, a lithographic printing plate precursor (1) was obtained.

Undercoat solution (1)

| | |
|---|---|
| Water | 15 g |
| Methanol | 135 g |
| Compound A shown below | 0.72 g |

Compound A:

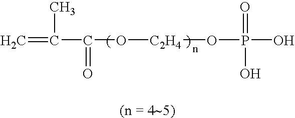

Coating solution (1) for image-forming layer

| | |
|---|---|
| Binder polymer (1) | 0.162 g |
| Polymerization initiator (1) | 0.100 g |
| Infrared absorbing agent (1) | 0.020 g |
| Polymerizable compound (Aronics M-215, produced | 0.385 g |
| by Toagosei Co., Ltd.) | |
| Fluorine-based surfactant (1) | 0.044 g |
| Aqueous dispersion (1) of stratiform compound shown | 2.500 g |
| below | |
| Methyl ethyl ketone | 1.091 g |
| 1-Methoxy-2-propanol | 8.609 g |
| Deionized water | 2.500 g |

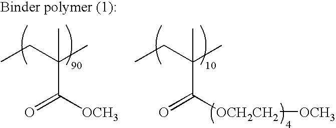

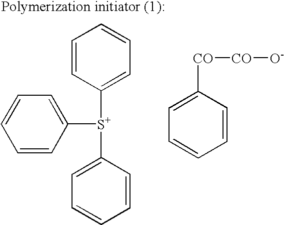

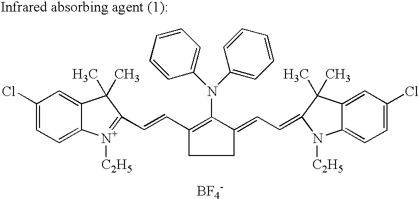

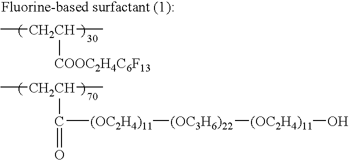

Preparation of Aqueous Dispersion (1) of Stratiform Compound

To 193.6 g of deionized water was added 6.4 g of synthetic mica (Somasif ME-100, produced by CO-OP Chemical Co., Ltd.) and the mixture was dispersed by using a homogenizer until an average particle size (according to a laser scattering method) became 3 μm. The aspect ratio of the inorganic fine particle thus-obtained was 100 or more.

### Example 2

A coating solution (2) for image-forming layer shown below was bar-coated on Support B described above and dried in an oven at 100° C. for 60 seconds so as to have a dry coating amount of 1.0 mg/m². Thus, a lithographic printing plate precursor (2) was obtained.

Coating solution (2) for image-forming layer

| | |
|---|---|
| Binder polymer (1) | 0.162 g |
| Polymerization initiator (1) | 0.100 g |
| Infrared absorbing agent (1) | 0.020 g |
| Polymerizable compound (Aronics M-215, produced | 0.385 g |
| by Toagosei Co., Ltd.) | |
| Fluorine-based surfactant (1) | 0.044 g |
| Aqueous dispersion (1) of stratiform compound shown | 2.500 g |
| below | |
| Compound A described above (compound having | 0.020 g |
| polymerizable group and adsorbing group to support | |
| Methyl ethyl ketone | 1.091 g |
| 1-Methoxy-2-propanol | 8.609 g |
| Deionized water | 2.500 g |

### Example 3

The coating solution (1) for image-forming layer was bar-coated on Support B described above and dried in an oven at 100° C. for 60 seconds so as to have a dry coating amount of 1.0 mg/m². Thus, a lithographic printing plate precursor (3) was obtained.

### Example 4

An undercoat solution (2) shown below was bar-coated on Support A described above and dried in an oven at 80° C. for 20 seconds so as to have a dry coating amount of 10 mg/m². On the undercoat layer thus obtained, a coating solution (3) for image-forming layer shown below was bar-coated and dried in an oven at 100° C. for 60 seconds so as to have a dry coating amount of 1.0 mg/m². Thus, a lithographic printing plate precursor (4) was obtained.

Undercoat solution (2)

| | |
|---|---|
| Compound B shown below | 0.017 g |
| Methanol | 9.00 g |
| Water | 1.00 g |

Compound B:

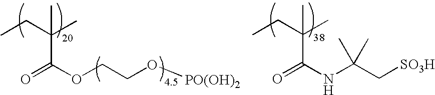

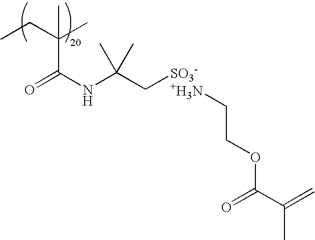

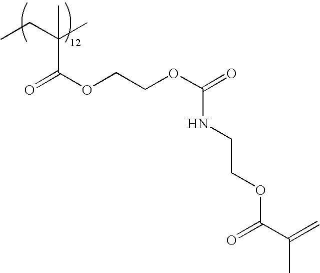

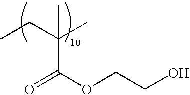

Coating solution (3) for image-forming layer

| | |
|---|---|
| Binder polymer (1) | 0.162 g |
| Polymerization initiator (1) | 0.100 g |
| Infrared absorbing agent (1) | 0.020 g |
| Polymerizable compound (Aronics M-215, produced | 0.385 g |
| by Toagosei Co., Ltd.) | |
| Fluorine-based surfactant (1) | 0.044 g |
| Aqueous dispersion (1) of stratiform compound shown | 2.500 g |
| below | |
| Methyl ethyl ketone | 1.091 g |
| 1-Methoxy-2-propanol | 8.609 g |
| Fine particles (1) synthesized below | 2.640 g |
| Aqueous dispersion (1) of stratiform compound shown | 2.500 g |
| below | |

Synthesis of Fine Particle (1)

An oil phase component was prepared by dissolving 10 g of an adduct of trimethylol propane and xylene diisocyanate (Takenate D-110N, produced by Mitsui Takeda Chemical Co., Ltd., 75% by weight ethyl acetate solution), 6.00 g of Aronix SR-399 (produced by Toagosei Co., Ltd.) and 0.12 g of Pionine A-41C (produced by Takemoto Oil and Fat Co., Ltd.) in 16.67 g of ethyl acetate. As an aqueous phase component, 37.5 g of a 4% by weight aqueous solution of PVA-205 was prepared. The oil phase component and the aqueous phase component were mixed and emulsified by using a homogenizer at 12,000 rpm for 10 minutes. The resulting emulsion was added to 25 g of distilled water and stirred at a room temperature for 30 minutes and then at 40° C. for 2 hours. The thus obtained fine particle liquid was diluted with distilled water so as to have the solid concentration of 15% by weight. The average particle size of the fine particle was 0.2 82 m.

### Example 5

A lithographic printing plate precursor (5) was produced as in Example 4 but using an aqueous dispersion (2) of stratiform compound shown below as a substitute for the aqueous dispersion of stratiform compound (1).

Preparation of Aqueous Dispersion (2) of Stratiform Compound

To 193.6 g of deionized water was added 6.4 g of synthetic mica (Somasif ME-100, produced by CO-OP Chemical Co., Ltd.) and the mixture was dispersed by using a homogenizer until an average particle size (according to a laser scattering method) became 0.5 μm. The aspect ratio of the inorganic fine particle thus-obtained was 100 or more.

Example 6

A coating solution (3) for image-forming layer shown below was bar-coated on Support A described above and dried in an oven at 100° C. for 60 seconds so as to have a dry coating amount of 1.0 Mg/m². Thus, a lithographic printing plate precursor (6) was obtained.

Example 7

The undercoat solution (2) was bar-coated on Support A described above and dried in an oven at 80° C. for 20 seconds so as to have a dry coating amount of 10 mg/m². On the undercoat layer thus obtained, a coating solution (4) for image-forming layer shown below was bar-coated and dried in an oven at 100° C. for 60 seconds so as to have a dry coating amount of 1.0 mg/m². Thus, a lithographic printing plate precursor (7) was obtained.

Coating solution (4) for image-forming layer

| | |
|---|---|
| Binder polymer (2) shown below | 0.162 g |
| Polymerization initiator (1) | 0.100 g |
| Infrared absorbing agent (1) | 0.020 g |
| Polymerizable compound (Aronics M-215, produced | 0.385 g |
| by Toagosei Co., Ltd.) | |
| Fluorine-based surfactant (1) | 0.044 g |
| Acetone dispersion of stratiform compound shown | 12.500 g |
| below | |
| Acetone | 12.200 g |

Binder polymer (2):

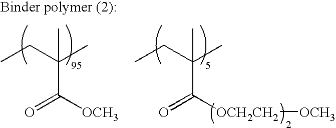

Preparation of Acetone Dispersion of Stratiform Compound

To 193.6 g of acetone was added 6.4 g of quaternary ammonium-denatured synthetic mica (Somasif MPE, produced by CO-OP Chemical Co., Ltd.) and the mixture was dispersed by using a homogenizer until an average particle size (according to a laser scattering method) became 3 μm. The aspect ratio of the inorganic fine particle thus-obtained was 100 or more

### Comparative Example 1

A comparative lithographic printing plate precursor (1) was prepared as in Example 3 but adding no aqueous solution of stratiform compound to the coating solution for image-forming layer.

### Comparative Example 2

A comparative lithographic printing plate precursor (2) was prepared as in Example 1 but adding no aqueous solution of stratiform compound to the coating solution for image-forming layer.

### Comparative Example 3

A comparative lithographic printing plate precursor (3) was prepared as in Example 6 but adding no aqueous solution of stratiform compound to the coating solution for image-forming layer.

[Exposure and printing]

The obtained lithographic printing plate precursor was exposed by Trendsetter 3244VX, produced by Creo Co., equipped with a water-cooled 40 W infrared semiconductor laser under the conditions of power of 9 W, a rotational number of an outer surface drum of 150 rpm and resolution of 2,400 dpi. The exposed image had a fine line chart. The exposed lithographic printing plate precursor was mounted on a plate cylinder of a printing machine (SOR-M, produced by Hyderberg Co.) without development. After supplying dampening water [EU-3 (etching solution, produced by Fuji Photo Film Co., Ltd.)/water/isopropyl alcohol=1/89/10 (volume ratio)] and ink (TRANS-G (N) black ink (produced by Dainippon Ink and Chemicals, Inc.), 100 sheets of printing was conducted at a printing speed of 6,000 sheets per hour. A number of printing papers required until on-machine development of the unexposed area of the image-forming layer on the printing machine was completed to reach a state where the ink was not transferred to the printing paper in the non-image area was determined to evaluate the on-machine developing property. As a result, stain-free prints were obtained up to 100 sheets by using each lithographic printing plate precursor.

[Evaluation]

In a negative type lithographic printing plate precursor, the degree of hardening of the image-forming layer (photosensitive layer) is lowered with a decrease in the exposure amount, while the degree of hardening is elevated with an increase in the exposure amount. In the case where the degree of hardening of the image-forming layer is too low, the lithographic printing plate precursor has low printing durability and poor reproducibility of small dots and fine lines. In the case In the case where the degree of hardening of the image-forming layer is high, on the other hand, the lithographic printing plate precursor has high printing durability and good reproducibility of small dots and fine lines.

In this Example, the negative lithographic printing plate precursor obtained above was evaluated in printing durability and fine line reproducibility under the same exposure conditions as described above to thereby give sensitivity indication of the lithographic printing plate precursor. Namely, a larger number of prints in the printing durability test and a thinner line width in the fine line reproducibility test indicate each the higher sensitivity of a lithographic printing plate precursor.

Moreover, printing durability, adhesion to paper board, time-lapse stability and abrasion due to exposure were evaluated in the following manner. Table 1 summarizes the results.

(1) Fine Line Reproducibility

As discussed above, 100 sheets of printing was conducted and it was confirmed that ink stain-free prints were obtained. Subsequently, 500 sheets of printing was further conducted. The fine line charts (wherein fine lines of 10, 12, 14, 16, 18, 20, 25, 30, 35, 40, 60, 80, 100 and 200 μm had been exposed) in 600 prints in total were observed under a loupe 25× magnification and the fine line reproducibility was evaluated based on the width of fine lines reproduced by the ink without cutting.

(2) Printing Durability

After conducting 600 sheets of printing as described above in the evaluation of the fine line reproducibility, the printing was further continued. As the number of printing sheets was increased, the image-forming layer was gradually abraded and the ink receptivity was lowered. Thus, the ink density on the printing paper decreased. A number of prints obtained until the ink density (reflection density) decreased by 0.1 from that at the initiation of printing was determined to evaluate the printing durability.

(3) Adhesion

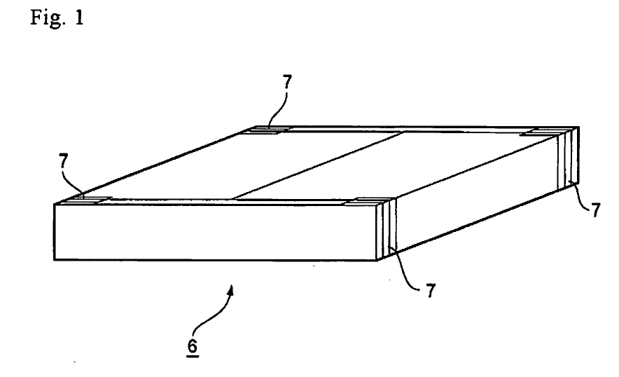

The obtained lithographic printing plate precursor was layered on a paper board so that the image-forming layer-coated face was in contact directly with the paper board. Thus, a laminate having 50 sheets of the lithographic printing plate precursor was constructed. The paper board employed had a weighing of 48 g/m², a thickness of 60 μm, a density of 0.80 g/cm³ and a smoothness of 310 sec. This laminate was packaged in craft paper having aluminum foil bonded to the inner face thereof as shown in FIG. 1 and fixed with a pressure-sensitive adhesive tape to give a package. Assuming poor distribution and storage conditions, this package was allowed to stand at 45° C. and humidity 75% for 1 week and then opened. Thus, the adhesion between the image-forming layer-coated face and the paper board was evaluated. In the evaluation, “A” stands for a case where the lithographic printing plate precursor could be separated from the paper board, while “B” stands for a case where the separation was difficult due to the adhesion of the lithographic printing plate precursor to the paper board.

(4) Time-lapse Stability

In a negative image-forming layer, the polymerization initiator is generally decomposed with the lapse of time to cause lowering in reactivity, i.e., lowering in sensitivity. The fine line reproducibility of the lithographic printing plate precursor, which had been stored at 45° C. and humidity 75% for 1 week as described above, was evaluated in the same manner as described above to evaluate the time-lapse stability. A lithographic printing plate precursor showing lowering in the fine line reproducibility after the storage at 45° C. and 75% RH was determined as having poor time-lapse stability.

(5) Abrasion Property

The obtained lithographic printing plate precursor was continuously exposed five times by Trendsetter 3244VX, produced by Creo Co. Then, stain in the optical system of the plate setter was observed with the naked eye. In the evaluation, “A” stands for a case where no stain was observed, while “B” stands for a case where stain was observed.

TABLE 1
Evaluation results

| | | Evaluation results | | | | |
|---|---|---|---|---|---|---|
| | Lithographic | (1) Fine line | (2) Printing | | (4) Time-lapse | |
| | printing precursor | reproducibility | durability | | stability | (5) Abrasion |
| | no. | (μm) | (1000 sheets) | (3) Adhesion | (μm) | property |
| Ex. 1 | (1) | 16 | 15 | A | 16 | A |
| Ex. 2 | (2) | 16 | 12 | A | 16 | A |
| Ex. 3 | (3) | 25 | 8 | A | 25 | A |
| Ex. 4 | (4) | 16 | 12 | A | 16 | A |
| Ex. 5 | (5) | 20 | 8 | A | 25 | A |
| Ex. 6 | (6) | 16 | 10 | A | 16 | A |
| Ex. 7 | (7) | 16 | 20 | A | 16 | A |
| Comp. Ex. 1 | Comp. (1) | No image | No image | B | No image | B |
| Comp. Ex. 2 | Comp. (2) | 40 | 3 | B | No image | B |
| Comp. Ex. 3 | Comp. (39 | 40 | 2 | B | No image | B |

By comparing the comparative lithographic printing plate precursor (1) with the lithographic printing plate precursor (3), the comparative lithographic printing plate precursor (2) with the lithographic printing plate precursor (1), and the comparative lithographic printing plate precursor (3) with the lithographic printing plate precursor (6) in Table 1, it can be understood in each case that the addition of the stratiform compound to the image-forming layer causes improvements in sensitivity (fine line reproducibility and printing durability), adhesion, time-lapse stability and abrasion property.

### Example 8

A lithographic printing plate precursor (8) was produced as in Example 4 but using a microgel (1) shown below as a substitute for the fine particles (1) in Example 4 and the obtained lithographic printing plate precursor was evaluated.

As a result, the fine line reproducibility was 16 μm, the printing durability was 10,000 sheets, the adhesion was “A”, the time-lapse stability was 16 μm and the abrasion property was “A”.

(Synthesis of Microgel (1))

An oil phase component was prepared by dissolving 10 g of an adduct of trimethylol propane and xylene diisocyanate (Takenate D-110N, produced by Mitsui Takeda Chemical Co., Ltd., 75% by weight ethyl acetate solution), 3.15 g of pentaerythritol triacrylate (SR444 Produced by Nippon Kayaku) and 0.1 g of Pionine A-41C (produced by Takemoto Oil and Fat Co., Ltd.) in 17 g of ethyl acetate. As an aqueous phase component, 40 g of a 4% by weight aqueous solution of PVA-205 was prepared. The oil phase component and the aqueous phase component were mixed and emulsified by using a homogenizer at 12,000 rpm for 10 minutes. The resulting emulsion was added to 25 g of distilled water and stirred at a room temperature for 30 minutes and then at 50° C. for 3 hours. The thus obtained microgel was diluted with distilled water so as to have the solid concentration of 15% by weight. The average particle size of the fine particle was 0.2 μm.

This application is based on Japanese Patent application JP 2005-81500, filed Mar. 22, 2005, and Japanese Patent application JP 2005-355193, filed Dec. 8, 2005, the entire contents of which are hereby incorporated by reference, the same as if set forth at length.

What is claimed is:

1. A lithographic printing plate precursor comprising a support and an image-forming layer which is capable of being removed with at least one of a printing ink and dampening water, wherein the image-forming layer contains a stratiform compound.

2. The lithographic printing plate precursor as claimed in claim 1, wherein the stratiform compound has an aspect ratio of 20 or more.

3. The lithographic printing plate precursor as claimed in claim 1, wherein the stratiform compound has an aspect ratio of 100 or more.

4. The lithographic printing plate precursor as claimed in claim 1, wherein the stratiform compound has an aspect ratio of 200 or more.

5. The lithographic printing plate precursor as claimed in claim 1, further comprising an undercoat layer between the support and the image-forming layer, the undercoat layer containing a compound having a polymerizable group.

6. The lithographic printing plate precursor as claimed in claim 1, wherein the image-forming layer further contains a compound having a polymerizable group and an adsorbing group to the support in its molecule.

7. The lithographic printing plate precursor as claimed in claim 1, wherein the image-forming layer contains a microcapsule or a microgel.

8. The lithographic printing plate precursor as claimed in claim 1, wherein the stratiform compound contains an organic cation.

9. The lithographic printing plate precursor as claimed in claim 1, wherein the stratiform compound has an average particle size of from 1 to 20 μm.

10. A printing method comprising:
loading a lithographic printing plate precursor including a support and an image-forming layer containing a stratiform compound on a printing machine and imagewise exposing the loaded lithographic printing plate precursor with an infrared laser, or imagewise exposing a lithographic printing plate precursor including a support and an image-forming layer containing a stratiform compound with an infrared laser and loading the exposed lithographic printing plate precursor on a printing machine; and
supplying a printing ink and dampening water to the loaded and exposed lithographic printing plate precursor to remove an infrared laser-unexposed area of the image-forming layer.
